(19) United States
(12) Patent Application Publication
(10) Pub. No.: US 2024/0094891 A1
(43) Pub. Date: Mar. 21, 2024

(54) SYSTEMS AND METHODS FOR ENHANCING CONTENT VISIBILITY IN A MULTI-LAYER DISPLAY

(71) Applicant: Mobeus Industries, Inc., Sparta, NJ (US)

(72) Inventor: Dharmendra ETWARU, Sparta, NJ (US)

(21) Appl. No.: 18/369,122

(22) Filed: Sep. 15, 2023

Related U.S. Application Data
(60) Provisional application No. 63/407,489, filed on Sep. 16, 2022.

(51) Int. Cl. G06F 3/04847; G06F 3/0481; G06T 19/20

(52) U.S. Cl. CPC G06F 3/04847; G06F 3/0481; G06T 19/20; G06F 2203/04804; G06T 2200/24; G06T 2210/62; G06T 2219/2012

(57) ABSTRACT

A system and method for enhancing the viewability of content in a multi-layer display.

### CROSS REFERENCE TO RELATED APPLICATIONS

The present application is a Non-Provisional of and claims priority to U.S. Provisional Application No. 63/408,012, filed Sep. 19, 2022, the entire contents of which is incorporated by reference herein in its entirety for all purposes.

### TECHNICAL FIELD

This disclosure relates to the field of systems and methods configured to enhance the clarity of content displayed via a multi-layer arrangement.

### SUMMARY

The disclosed technology relates to systems and methods for enhancing the readability of content displayed in a multi-layer arrangement. According to some embodiments, the systems and methods include generating a platform GUI in a display area of a device. Digital content is received from a first content input source and from a second content input source. Modified content output layers are generated for each of the input sources. Specifically, a first output layer is generated based on modifying the digital content of the first content input source in accordance with a first enhancement profile and a second content output layer is generated based on modifying the digital content of the second content input source with a second enhancement profile. The content output layers are superimposed relative to one another and displayed within the platform GUI.

In some embodiments, each enhancement profile identifies: a number of duplicate layers of the digital content of a content input source that are to be generated, as well as one or more specific image variable parameters that are to be applied to each duplicate layer. In some embodiments, generating the first content output layer thus includes generating one or more duplicate layers of the digital content of the first content input source. The number of duplicate layers of the digital content of the first content input source that are generated corresponds to the number identified in the first enhancement profile. Generating the first content output layer thus includes generating one or more duplicate layers of the digital content of the first content input source, and further includes—for each generated duplicate layer—modifying the digital content of the duplicate layer based on the specific one or more image variable parameters assigned to the duplicate layer. The one or more specific image variable parameters the are modified correspond to at least one of: hue, saturation, brightness, transparency contrast, color map, blur, or sharpness. Once each of the duplicate layers have been modified, the group of modified duplicate layers is compiled to generate the content output layer for the first input source. In some embodiments, the first enhancement profile is different than the second enhancement profile.

In some embodiments, the enhancement profiles that are assigned to—and which are used to modify the digital content of—the first and second content input sources are selected based on a user selection of a desired preconfigured visual effect enhancement setting. In some embodiments, the enhancement profiles are additionally, or alternatively assigned based on an assessment of the color profiles of the digital content of each of the first content input source and second content input source. In yet other embodiments, the enhancement profiles are additionally, or alternatively assigned based on an identification of the type of digital content received from the first content input source and second content input source. According to various embodiments, the first content input source is a runtime GUI of a communications platform, and the second content input source is a desktop GUI.

According to some embodiments, the systems and methods further include receiving digital content from a third content input source corresponding to a hotspot identified within the desktop GUI. A highlight profile is used to modify the digital content of the hotspot, and thereby generate a hotspot output layer. The hotspot output layer may be displayed by the platform GUI such that the hotspot output layer is superimposed in front of each of the first and second content output layers. The hotspot output layer may be entirely opaque (i.e., non-transparent). In some embodiments, the second content output layer is entirely transparent, such that only the digital content of the first content input source (e.g., the runtime GUI of a communications platform) and the hotspot are visible on the platform GUI. In other embodiments, the second content output layer may be semi-transparent.

The above features and advantages of the present invention will be better understood from the following detailed description taken in conjunction with the accompanying drawings.

### BRIEF DESCRIPTION OF THE DRAWINGS

FIG. 1 schematically illustrates a system of implementing transparency control devices with communications platforms according to some configurations.

FIG. 2 schematically illustrates a user device or a server of the system of FIG. 1 according to some configurations.

FIG. 3 schematically illustrates an example of an augmentation configured to manage, manipulate, and merge multiple layers of content, according to some configurations.

FIG. 4 schematically illustrates a multi-layer display according to some configurations.

FIG. 5 is a schematic diagram conceptually illustrating a visual enhancement application used to enhance the ability of a user to read and discern content within a multi-layer display, according to some configurations.

FIG. 6 is a flowchart illustrating an example method and technique for enhancing the clarity of content displayed via a multi-layer arrangement using the visual enhancement application of FIG. 5, in accordance with various aspects of the techniques described in this disclosure.

FIG. 7A is a schematic diagram conceptually illustrating an example platform GUI rendered within a display area of a user device or a server of the system of FIG. 1 according to some configurations.

FIG. 7B is a schematic diagram conceptually illustrating an example projector area of a platform GUI according to some configurations.

FIG. 8 schematically illustrates a multi-layer display generated using the visual enhancement application of FIG. 5, according to some configurations.

FIG. 9A schematically illustrates a multi-layer display generated using the visual enhancement application of FIG. 5, according to some configurations.

FIG. 9B is a schematic illustrating a multi-layer display having a visual effect applied thereto in accordance with an enhancement visual effect setting selected by a user using the visual enhancement application of FIG. 5, according to some configurations.

FIG. 10 is a flowchart illustrating an example method and technique for enhancing the clarity of content displayed using an input manipulation module of the visual enhancement application of FIG. 5, in accordance with various aspects of the techniques described in this disclosure.

FIG. 11 schematically illustrates a multi-layer display generated using an input manipulation module of the visual enhancement application of FIG. 5, in accordance with various aspects of the techniques described in this disclosure.

FIG. 12 is a flowchart illustrating an example method and technique for enhancing the clarity of content displayed using a hotspot module of the visual enhancement application of FIG. 5, in accordance with various aspects of the techniques described in this disclosure.

FIG. 13 schematically illustrates hotspots identified within the contents of an input source corresponding to a user's desktop GUI which is shown displaying the contents of a web-browser.

FIGS. 14A-14E are schematic diagrams conceptually illustrating the hotspot layers generated by the hotspot module of the visual enhancement application of FIG. 5 based on the content from the input source shown in FIG. 13, in accordance with various aspects of the techniques described in this disclosure.

FIG. 15A schematically illustrates a multi-layer display generated using a hotspot module of the visual enhancement application of FIG. 5 in the absence of a predetermined visual modification threshold being detected, in accordance with various aspects of the techniques described in this disclosure.

FIG. 15B schematically illustrates the multi-layer display of FIG. 15B as visually modified by the application of highlighting by the hotspot module responsive to the detection of a predetermined visual modification threshold having been met, in accordance with various aspects of the techniques described in this disclosure.

### DETAILED DESCRIPTION

The disclosed technology will now be discussed in detail with regard to the attached drawing figures that were briefly described above. In the following description, numerous specific details are set forth illustrating the Applicant's best mode for practicing the invention and enabling one of ordinary skill in the art to make and use the invention. One skilled in the art will recognize that embodiments of the present invention may be practiced without many of these specific details. In other instances, well-known machines, structures, and method steps have not been described in particular detail in order to avoid unnecessarily obscuring embodiments of the present invention. Unless otherwise indicated, like parts and method steps are referred to with like reference numerals.

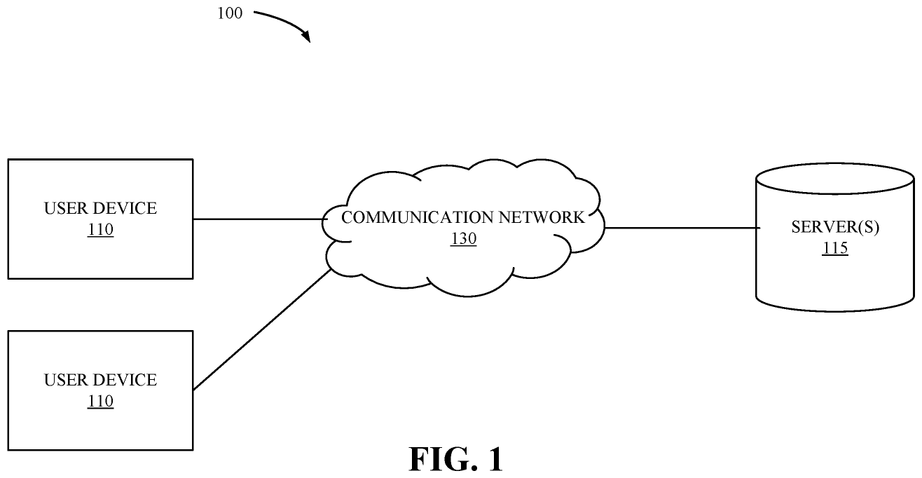

FIG. 1 illustrates a system 100 for implementing a visual enhancement application in association with a communications platform according to some configurations. In the illustrated example of FIG. 1, the system 100 can include one or more user devices 110 (referred to collectively herein as “the user devices 110” and individually as “the user device 110”) and/or a server 115. In some configurations, the system 100 can include fewer, additional, or different components in different configurations than illustrated in FIG. 1. As one non-limiting example, the system 100 can include multiple servers 115. As another non-limiting example, the system 100 includes one or more user devices 110 with or without a server 115. As yet another non-limiting example, one or more components of the system 100 can be combined into a single device, divided among multiple devices, or a combination thereof.

The user devices 110 and the server 115 can communicate over one or more wired or wireless communication networks 130. Portions of the communication networks 130 can be implemented using a wide area network, such as the Internet, a local area network, such as a Bluetooth™ network or Wi-Fi, and combinations or derivatives thereof. Alternatively, or in addition, in some configurations, two or more components of the system 100 can communicate directly as compared to through the communication network 130. Alternatively, or in addition, in some configurations, two or more components of the system 100 can communicate through one or more intermediary devices not illustrated in FIG. 1.

The user device 110 can include a computing device, such as a desktop computer, a laptop computer, a tablet computer, a terminal, a smart telephone, a smart television, a smart wearable, or another suitable computing device that interfaces with a user. As described in greater detail herein, the user device 110 can be used by a user for interacting with a communications platform, such as, e.g., a communications platform hosted or otherwise provided by the user device 110 or the server 115 (as described in greater detail herein). A user interaction with a communications platform may include, e.g., hosting a communication session, participating in a communication session, preparing for a future communication session, viewing a previous communication session, and the like. A communication session may include, for example, a video conference, a group call, a webinar (e.g., a live webinar, a pre-recorded webinar, and the like), a collaboration session, a workspace, an instant messaging group, or the like. Accordingly, in some configurations, to communicate with another user device 110 or the server 115, the user device 110 may store a browser application or a dedicated software application (as described in greater detail herein).

In some examples, the server 115 or the user device 110 can be, for example, a server functioning as a communications platform as a service (CPaaS). The CPaaS is a cloud-based delivery model that allows organizations to add real-time communications capabilities, such as voice, video, and messaging, to applications by deploying application program interfaces (APIs). The CPaaS can facilitate aggregation and transmission of content between user devices 110. In an embodiment, in general, the CPaaS can customize the data transmitted to each participant device 110 after receiving data from each participant device 110 where the data can be the video data, shared content data, etc. Notably, the CPaaS provides a method to allow the user of the sharing device to share content inside the electronic communication session.

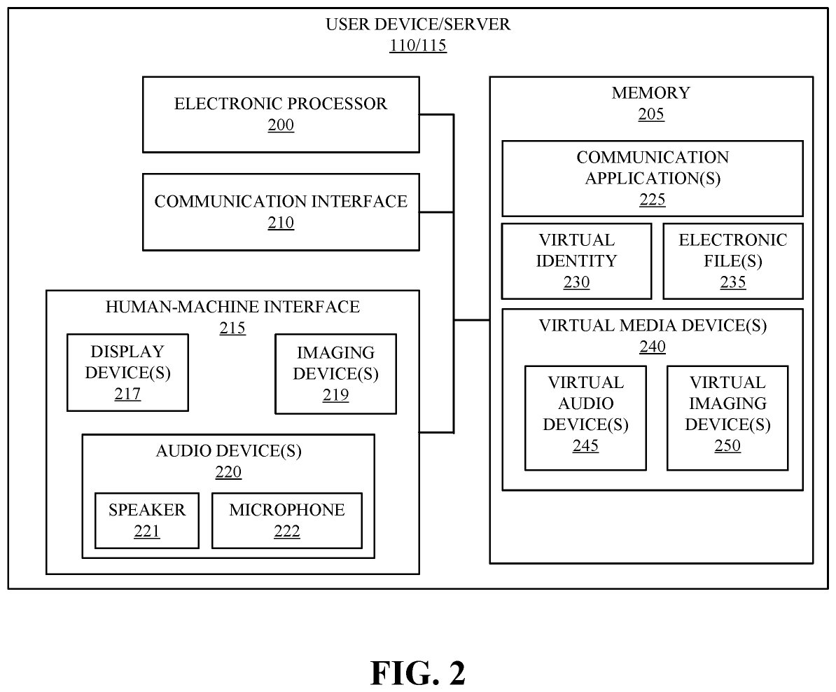

FIG. 2 schematically illustrates an example device (e.g., a user device 110 or a server 115) according to some configurations. As illustrated in FIG. 2, the device 110, 115 can include an electronic processor 200, a memory 205, a communication interface 210, and/or a human-machine interface (“HMI”) 215. The electronic processor 200, the memory 205, the communication interface 210, and the HMI 215 may communicate wirelessly, over one or more communication lines or buses, or a combination thereof. The device 110, 115 may include additional, different, or fewer components than those illustrated in FIG. 2 in various configurations. For example, the device 110 might not include the HMI 215 when the device is a server 215 and the server 215 does not join a communication session. The device 110, 115 may perform additional functionality other than the functionality described herein. Also, the functionality (or a portion thereof) described herein as being performed by the device 110, 115 may be performed by another component (e.g., the server 115, another computing device, or a combination thereof), distributed among multiple computing devices (e.g., as part of a cloud service or cloud-computing environment), combined with another component (e.g., the server 115, another computing device, or a combination thereof), or a combination thereof.

The communication interface 210 may include a transceiver that communicates with the server 115 in an embodiment where the device of FIG. 2 is user device 110, another user device of the system 100, or a combination thereof over the communication network 130 and, optionally, one or more other communication networks or connections. The electronic processor 200 includes a microprocessor, an application-specific integrated circuit (“ASIC”), or another suitable electronic device for processing data, and the memory 205 includes a non-transitory, computer-readable storage medium. The electronic processor 200 is configured to retrieve instructions and data from the memory 205 and execute the instructions.

As illustrated in FIG. 2, the device 110, 115 can also include the HMI 215 for interacting with a user or a non-human. The HMI 215 can include one or more input devices, one or more output devices, or a combination thereof. Accordingly, in some configurations, the HMI 215 allows a user to interact with (e.g., provide input to and receive output from) the device 110. For example, the HMI 215 can include a keyboard, a cursor-control device (e.g., a mouse), a touch screen, a scroll ball, a mechanical button, a display device (e.g., a liquid crystal display (“LCD”)), a printer, a speaker, a microphone, or a combination thereof. It should be appreciated that the input devices are not necessarily used by a user. The input/output devices can be utilized by a non-human (e.g., robot, predetermined/dynamic program). Also, it should be appreciated that the HMI 215 can also allow a device to interact with (e.g., provide input to and receive output from) the device 110. For example, the HMI can include an audiovisual device (e.g., a camera, an audio/video recorder, etc.) to capture the environment or certain action. The audiovisual automatically or manually provides or stops providing input (e.g., image, video, audio, etc.) by capturing the environment or certain action. In some examples, when the audiovisual device detects a user leaving the room, the audiovisual can stop providing the input to the device 110, can automatically mute the audio input, or can reduce the resolution of the image or video input.

In the illustrated example of FIG. 2, the HMI 215 can include at least one display device 217 (referred to herein collectively as “the display devices 217” and individually as “the display device 217”). The display device 217 can be included in the same housing as the device 110 or can communicate with the device 110 over one or more wired or wireless connections. As one non-limiting example, the display device 217 can be a touchscreen included in a laptop computer, a tablet computer, or a smart telephone. As another non-limiting example, the display device 217 may be a monitor, a television, or a projector coupled to a terminal, desktop computer, or the like via one or more cables.

As described in greater detail herein, the display device 217 can provide (or output) one or more media signals to a user. As one non-limiting example, the display device 217 can display a user interface (e.g., a graphical user interface (GUI)) associated with a communications platform (including, e.g., a communication session thereof), such as, e.g., a communication session user interface. As described in greater detail herein, the user interface can include a set of virtual representations. A virtual representation may include, e.g., a graphical representation of a virtual presence of a user, a panel, a teleport component (to be described in greater detail below). A virtual representation may include at least one of a profile picture, an image data stream (e.g., a video stream), a textual identifier (e.g., a user name, a nickname, a company, contact information, and the like), an avatar, a digital character representation, a logo or symbol (e.g., a company logo, a committee logo, and the like), an animation (e.g., a Graphics Interchange Format (GIF) or other bitmap image format rendering), and the like. In some configurations, each virtual representation is presented (rendered) within a virtual representation display window of the communication session user interface. In further configurations, each virtual representation can be presented or rendered via a panel or a teleport component of a GUI, which is described in greater detail below.

The HMI 215 can also include at least one imaging device 219 (referred to herein collectively as “the imaging devices 219” and individually as “the imaging device 219”). The imaging device 219 may be a physical or hardware component associated with the device 110 (e.g., included in the device 110 or otherwise communicatively coupled with the device 110). The imaging device 219 can also be referred to herein as a hardware imaging device. The imaging device 219 can electronically capture or detect a visual image (as an image data signal or data stream). A visual image may include, e.g., a still image, a moving-image, a video stream, other data associated with providing a visual output, and the like. The imaging device 219 can include a camera, such as, e.g., a webcam, an image sensor, or the like.

The HMI 215 may also include at least one audio device 220 (referred to herein collectively as “the audio devices 220” and individually as “the audio device 220”). The audio device 220 may be a physical or hardware component associated with the device 110 (e.g., included in the device 110 or otherwise communicatively coupled with the device 110). The audio device 220 can also be referred to herein as a hardware audio device. The audio device 220 can receive or detect an audio signal (as an audio data signal or data stream), output an audio signal, or a combination thereof. In some configurations, a single audio device 220 may receive and output an audio signal. Alternatively, or in addition, in some configurations, a first audio device 220 receives an audio signal while another audio device 220 outputs an audio signal. As one non-limiting example, as illustrated in FIG. 2, the audio devices 220 of the HMI 215 can include at least one speaker 221 and at least one microphone 222. The speaker 221 can receive an electrical audio signal, convert the electrical audio signal into a corresponding sound (or audible audio signal), and output the corresponding sound. The microphone 222 can receive an audible audio signal (e.g., a sound) and convert the audible audio signal into a corresponding electrical audio signal. Although not illustrated in FIG. 2, the HMI 215 may include additional or different components associated with receiving and outputting audio signals, such as, e.g., associated circuitry, component(s), power source(s), and the like, as would be appreciated by one of ordinary skill in the art.

As illustrated in FIG. 2, the memory 205 may include at least one communication application 225 (referred herein collectively as “the communication applications 225” and individually as “the communication application 225”). The communication application 225 is a software application executable by the electronic processor 200 in the example illustrated and as specifically discussed below, although a similarly purposed module can be implemented in other ways in other examples.

In some examples, the communication application 225 can be associated with at least one communications platform. As one non-limiting example, a user can access and interact with a corresponding communications platform via the communication application 225. In some configurations, the memory 205 can include multiple communication applications 225. In such configurations, each communication application 225 can be associated with a different communications platform. As one non-limiting example, the memory 205 can include a first communication application associated with a first communications platform, a second communication application associated with a second communications platform, and an n^{th} communication application associated with an n^{th} communications platform.

As described in more detail herein, the electronic processor 200 can execute the communication application 225 to enable user interaction with a communications platform (e.g., a communications platform associated with the communication application 225), such as, e.g., a communications platform hosted or otherwise provided by the server 115 (as described in greater detail herein). The communication application 225 can be a browser application that enables access and interaction with a communications platform, such as, e.g., a communications platform associated with the server 115. Alternatively, or in addition, the communication application 225 may be a dedicated software application that enables access and interaction with a communications platform, such as, e.g., a communications platform associated with the server 115.

In further examples, the communication application 225 can include a communications platform or an electronic communication platform (ECP). For example, the memory 205 of the device 110, 115 can include the communications platform. The electronic processor 200 of the device 110, 115 can run the communications platform to allow a user to conduct group conferencing with other device(s) of other user(s). In a non-limiting scenario, the communications platform of the device 110 (e.g., user device 110) can be directly connected to other device(s) of other user(s). In another non-limiting scenario, the communications platform is stored in the memory 205 of the server 115, and the user can communicate with other user(s) by accessing the communications platform in the server 115. In some examples, the communications platform as a video conferencing application can hide or display local screen content of the user device 110, automatically or on demand, during a communication or collaboration session showing remote screen content. In some embodiments, the communications platform is configured to allow on-demand access to the local screen content of the user device 110. For example, the communications platform may provide a graphical user interface (GUI) element that when selected (e.g., by the user of the user device 110) causes the local screen content to be displayed or hidden without being disconnected from the screen sharing session. In further examples, the communications platform can reside in the memory 205 of the server 115 or the user device 110. In a non-limiting scenario, when the communications platform is in the server 115, the user device(s) 110 can interact with the communications platform in the server 115 using a local communication application(s) 225 (e.g., a browser application or a dedicated software application) of the user device(s) 110. In another non-limiting scenario, the communications platform can reside in the memory 205 of the user device 110. For example, the user device 110 can use the communications platform in the user device 110 and interact with other communications platform(s) of other user device(s) 110 or a communications platform in the server 115.

In the illustrated example of FIG. 2, the memory 205 can store at least one virtual identity 230. The virtual identity 230 can be associated with (or linked to) a user. A virtual identity 230 can be a virtual user profile of a user (such as a virtual identity profile). As described in greater detail herein, the virtual identity 230 can be a portable identity that is linked to a user such that as the user interacts with various application (or communications platforms) that user's identity is implemented in those different applications (or communications platforms). In some configurations, the virtual identity 230 is associated with a reputation of a user, such as, e.g., a financial reputation, a security or trustworthiness reputation, or the like. The virtual identity 230 can include a security rating, a transaction rating, another type of reputation rating, or a combination thereof. Alternatively, or in addition, the virtual identity 230 is associated with a user preference, such as, e.g., one or more user-based setting adjustment features, application-based setting adjustment features, another type of preferred parameter or setting of a user, or a combination thereof. A user preference can be a user defined or pre-set parameter or setting.

The virtual identity 230 can include a security rating for a user. The security rating may indicate or otherwise describe an authenticity of the user (e.g., verification of the identity of the user). The security rating can be based on a user's security settings or setting adjustment features, such as, e.g., a password strength (e.g., use of special characters, number of characters, character case, use of numerical characters, use of a random device generated password, whether the user's password is stored and automatically populated, age of password, or the like), an authentication process (e.g., single-step authentication, multi-factor authentication, and the like), factor(s) used in an authentication process (e.g., location, facial recognition, fingerprint recognition, gesture recognition, and the like), a device accessibility (e.g., a public device, a shared device, a private device, or the like), and the like. As one non-limiting example, a user who logs into an account using facial recognition can have a better or stronger security rating than another user who logs into an account using a password. As another non-limiting example, a user who updates their password weekly can have a better or stronger security rating than another user who has not updated their password.

The virtual identity 230 may include a transaction rating for a user. The transaction rating may indicate or otherwise describe a transaction credibility of the user (e.g., a credibility of the user with respect to transactions). The transaction rating can be based on a transaction history of the user, such as, e.g., a transaction history length (e.g., a length of time in which the user has been transacting), a number of total transactions, a number of transactions per transaction category or industry, a number of transactions per transaction method type, an active period for a transaction method type (e.g., a length of time in which the transaction type has been active), previous-transaction reviews (e.g., a review from another user who has previously transacted with the user), a length of time between transactions (e.g., which may indicate a likelihood of fraudulent transactions), and the like. A transaction type can refer to a type of transaction (e.g., a method of performing a transaction). A transaction type can include, e.g., a cash transaction, a checking account transaction, a savings account transaction, a debit card transaction, a credit card transaction, a mobile transaction, an electronic bank transaction, and the like. A transaction category can include, e.g., a category or industry associated with the transaction, such as, e.g., book transactions, carpool or travel transactions, content creation transactions, tutoring transactions, or the like. As one non-limiting example, a first user who has not yet transacted with another user will have a lower transaction rating than a second user who has transacted with five-hundred other users for a duration of six months. As another non-limiting example, a user's transaction history can indicate that the user has conducted one-hundred transactions within the last five minutes. Following this non-limiting example, given it is impractical for a single user to perform one-hundred transactions within five minutes, it is likely this user is engaging in fraudulent transactions. As such, according to this non-limiting example, the transaction rating for the user can indicate a low credibility for that user given the high likelihood of the user engaging in fraudulent transactions.

Alternatively, or in addition, a transaction type can include an exchange of goods, services, or a combination thereof, such as, e.g., a barter or trade transaction. As one non-limiting example, a transaction between users can include the exchange of digital content where a first user provides digital content to a second user and the second user provides digital content to the first user. In this non-limiting example, the digital content can include, e.g., digital rendering(s), digital illustration(s) or drawing(s), electronic notes(s) or outline(s) prepared by the first user with respect to an educational course, a seminar, a webinar, or the like, digital photograph(s), and the like. Accordingly, a transaction can include an exchange of currency, goods, services, or a combination thereof. As such, the disclosed technology can be implemented with respect to the exchange of currency, goods, services, or a combination thereof.

The virtual identity 230 can include at least one user preference (also referred to herein as “a user preference parameter”). As noted above, the user preference parameter can indicate or otherwise describe a preferred parameter or setting of the user. The user preference parameter can include at least one of, e.g., a background parameter, a visual effect parameter, a virtual representation display parameter, an other-user parameter, an audio parameter, a command parameter, an augmentation parameter, and the like.

A background parameter can include a selection of a background image, a background effect, another background setting, or a combination thereof to be used when a user participates in a communication session. As one non-limiting example, a user can select an image of a beach to be used as a background image when the user participates in a communication session. As another non-limiting example, a user can select a blur effect to be used as a background effect when the user participates in a communication session.

A visual effect parameter can include a selection of an image filter (e.g., a sepia image filter, a noir filter, and the like), an exposure setting, a brilliance setting, a highlights setting, a shadow setting, a contrast setting, a brightness setting, a black point setting, a saturation setting, a vibrance setting, a warmth setting, a tint setting, a sharpness setting, a definition setting, a noise reduction setting, a vignette setting, an image correction setting (e.g., a skin smoothing setting, a blemish removing setting, a make-up correction or application setting, or the like), and the like.

A virtual representation display parameter may include a selection of a virtual representation, a virtual representation display (“VRD”) window position, a virtual representation source (e.g., a storage location of the virtual representation, a source providing (or streaming) the virtual representation, and the like), or the like. As described in greater detail herein, a virtual representation can include, e.g., a graphical representation of a virtual presence of a user. A virtual representation can include at least one of a profile picture, an image data stream (e.g., a video stream), a textual identifier (e.g., a user name, a nickname, a company, contact information, and the like), an avatar, a digital character representation, a logo or symbol (e.g., a company logo, a committee logo, and the like), an animation (e.g., a GIF or other bitmap image format rendering), and the like. Accordingly, in some configurations, a virtual representation, a virtual representation source, or related parameter can be included in the virtual identity 230 of a user.

A VRD window parameter may include a size, a position, alignment, or placement, a shape (e.g., a circle, a square, a rectangle, a triangle, or the like), or other display characteristic of a VRD window during a communication session (e.g., where a VRD window containing a virtual representation of a user is positioned or generated within a user interface, such as a communication session user interface). A position of a VRD window may include, e.g., an upper left corner of a communication session user interface, a lower right-hand corner of a communication session user interface, an upper middle position of a communication session user interface, another position within the communication session user interface, or a combination thereof. In some configurations, the VRD window can be displayed outside of (e.g., visually detached or untethered from) the communication session user interface. The VRD window can be a separate window or user interface positioned external to the communication session user interface. The VRD window may be superimposed, overlaid, overlapping, or the like with respect to the communication session user interface, another user interface of a communications platform, or the like. The VRD window parameter can be manually adjusted by a user (e.g., dragging and dropping the VRD window by a user during a communication session). Accordingly, in some configurations, the virtual identity 230 may define a default or initial parameter for the VRD window, where a user may later adjust or otherwise modify the VRD window parameter.

Alternatively, or in addition, a VRD window parameter may include a user selection of not providing a VRD window of the user (e.g., no VRD window is generated for the user such that the user does not see a preview of the user's virtual representation). A VRD window parameter can be associated with the user, another user, or a combination thereof. As one non-limiting example, the user can select a VRD window parameter associated with that user's VRD window, such that a VRD window of the user is generated within a communication session user interface based on the VRD window parameter (such as, e.g., as a circle in an upper left-hand corner of the communication session user interface). As another non-limiting example, the user can select a VRD window parameter associated with another user's VRD windows such that, during a communication session with the other user, the VRD window for the other user is generated based on the VRD window parameter selected by the user (such as, e.g., as an oval in a bottom left-hand corner of the communication session user interface).

An other-user parameter can include a pre-selected (or pre-determined) other user (e.g., a second user, a third user, or the like) and at least one parameter associated with the pre-selected other user (collectively referred to herein as an “other-user parameter”). A pre-selected other user can be associated with the at least one other-user parameter such that, when the pre-selected user participates in a communication session with the user, the pre-selected user's virtual presence within the communication session is provided (or generated) according to the at least one other-user parameter. A parameter associated with the pre-selected user can include, e.g., a display window position (e.g., where a VRD window of the pre-selected user is positioned during a communication session that includes the first user), a background parameter (e.g., how a background in the VRD window of the pre-selected user is provided or rendered), a visual effect parameter (e.g., an effect to apply to a virtual representation of the pre-selected user), another parameter or setting described herein, or a combination thereof.

As one non-limiting example, the virtual identity 230 may be associated with a first user, and the virtual identity 230 may specify that a second user should be generated with a fish-face augmentation (as an other-user parameter). Following this non-limiting example, when the first user participates in a communication session with the second user, a communication session user interface associated with the first user (e.g., a communication session user interface provided to the first user) will provide a virtual representation of the second user such that the virtual representation of the second user depicts the second user as having a fish-face.

Accordingly, in some configurations, the other-user parameter is implemented from a first user's perspective (e.g., the user associated with the virtual identity 230) and not the other-user's perspective (e.g., the pre-selected user associated with the other-user parameter). As one non-limiting example, the other-user parameter may only control the generation of a virtual representation of a second user (as a pre-selected other user) as displayed or otherwise provided to a first user, and not a virtual representation of the second user displayed or otherwise provided to the second user. However, in other configurations, the other-user parameter is implemented from both the first user's perspective and the second user's perspective (e.g., the pre-selected other user's perspective). In such configurations, the other user may be prompted to allow implementation of such other-user parameters (collectively or on an individual basis per other-user parameter), to pre-emptively consent to implementation of one or more of the other-user parameters, or the like.

The audio parameter can include, e.g., a noise cancelation setting, a mute setting, an audio filter (e.g., an audio distortion filter), a volume setting, a gain setting, an equalizer setting, an audio augmentation setting, or the like. A noise cancelation setting can include, e.g., a setting that cancels a portion of an audio signal (or one or more additional audio signals other than the user's own audio signal). As one non-limiting example, a user can set a noise cancelation setting such that any audio signal (or portion thereof) that is associated with background noise, such as a dog barking, a lawnmower, a siren, or the like, is automatically removed. A mute setting can include, e.g., a setting that triggers activation or deactivation of a mute function. As one non-limiting example, a user can set a mute setting such that the mute function is automatically activated (turned on) after a duration of time in which the user did not speak. As another non-limiting example, a user can set a mute setting such that a mute function is automatically deactivated (turned off) when the user starts speaking. As yet another non-limiting example, a user can set a mute setting such that a mute function is automatically activated (turned on) when a detected audio signal is not associated with the user (e.g., when the audio signal only includes background noise). As yet another non-limiting example, a user can set a mute setting such that a mute function is automatically activated (turned on) when a user leaves a field of view of a camera.

The command parameter can include, e.g., a command, an associated action or function performed in response to the command, additional command parameters, or a combination thereof. A command can be an audible command, such as, e.g., a spoken word, phrase, an audible tone or sound, another audible input or signal, or the like. As one non-limiting example, an audible command can include “Stop Recording,” “Share Screen,” “Leave Meeting,” or the like. Alternatively, or in addition, a command may be a visual command, such as, e.g., a gesture, an object, another visual input or signal, or the like. As one non-limiting example, the user can enable commands and pre-set a recording command such that when the user verbally says “Start Recording” (as an audible command) during a communication session, recording of the communication session is initiated (as a corresponding action of function), where the recording is saved to a designated storage location (as a first additional command parameter) and the recording is saved following a designated naming convention (as a second additional command parameter). As another non-limiting example, during a communication session, a user can hold up a stop sign (as a visual command object), where, in response to detecting the stop sign object, the communication session ends (as a corresponding action or function). As yet another non-limiting example, during a communication session, a user can hold their index finger up to their mouth (as a visual command gesture), which activates or deactivates a mute function (as a corresponding action or function).

The augmentation parameter can include, e.g., one or more augmentation preferences associated with the user. An augmentation preference can include a selection of one or more augmentations for implementation during a communication session. As one non-limiting example, a user can select an avatar augmentation, such as a cat-face augmentation for use during a communication session. Following this non-limiting example, when the user participates in the communication session, the virtual representation of the user includes the cat-face augmentation such that the virtual representation of the user depicts the user as having a cat face.

A user may be linked to the virtual identity 230 such that as a user interacts with various communications platforms (or other applications), those communications platforms (or other applications) are implemented based on the virtual identity 230 (or a portion thereof). Accordingly, the virtual identity 230 may be portable such that the virtual identity 230 follows the associated user across communications platforms (or other applications). Thus, the virtual identity 230 enables the transferability of a user profile such that the user profile may be implemented across multiple different communications platforms (or applications). This eliminates the need for users to manually replicate and save settings or preferences for each application (or communications platform). In other words, users do not need to create multiple, duplicate user profiles for each application, which improves the user experience by eliminating user experience friction generally associated with setting up user preferences and improves storage efficiencies and performance.

As one non-limiting example, when a user interacts with a first communications platform, the first communications platform is implemented based on the virtual identity 230. Following this non-limiting example, when the user interacts with a second different communications platform, the second communications platform is also implemented based on the virtual identity 230. In other words, based on this non-limiting example, both the first communications platform and the second communications platform are implemented based on the virtual identity 230 of the user.

In some configurations, a user can be associated with multiple virtual identities (e.g., a first virtual identity, a second virtual identity, a third virtual identity, or the like). Each virtual identity can be different with respect to at least one user preference parameter. Each virtual identity of a user can be associated with at least one of, e.g., a communications platform, an availability of a user preference parameter for a communications platform, a communication session topic, a participant, a participant grouping, a geographical location of the user, a time of day, a day of the week (e.g., a weekend day or a weekday), a season (e.g., winter, spring, summer, or fall), a holiday (e.g., New Year's Day), a user status (e.g., an out of the office status, a sabbatical leave status, or the like), or the like. Accordingly, in some instances, a user may tailor their virtual identity 230 based on one or more additional considerations.

As one non-limiting example, a first communications platform and a second communications platform may be associated with a first virtual identity while a third different communications platform may be associated with a second different virtual identity. Following this example, when the third communications platform does not offer a user preference parameter that is included in the first virtual identity, the second virtual identity may designate an alternative user preference parameter in place of the unavailable user preference parameter of the first virtual identity. As another non-limiting example, a communication session related to planning a family reunion (as a communication session topic) may be associated with a different virtual identity than a communication session related to planning an upcoming client presentation (as a communication session topic). As another non-limiting example, a first virtual identity may include an “office” background when a geographical location of the user aligns with a home address for the user (e.g., indicating that the user is working remotely) while a second virtual identity may not include a background when a geographical location of the user aligns with a work address for the user (e.g., indicating that the user is working in the office).

As illustrated in FIG. 2, the memory 205 can store one or more electronic files 235 (referred to herein collectively as “the electronic files 235” or individually as “the electronic file 235”). The electronic file 235 can also be referred to herein as electronic content. The electronic file 235 may include, for example, a word processor document, a diagram or vector graphic, a text file, an electronic communication (for example, an email, an instant message, or the like), a spreadsheet, an electronic notebook, an electronic drawing, an electronic map, a slideshow presentation, a task list, a webinar, a video, a graphical item, a code file, and the like. The electronic file 235 may include multiple forms of content, such as text, one or more images, one or more videos, one or more graphics, one or more diagrams, one or more charts, and the like. As described in greater detail herein, the electronic files 235 may be electronic content that is shared or otherwise presented during a communication session (e.g., as part of a screen sharing function, a content sharing function, or the like).

The memory 205 can store at least one virtual media device 240 (referred to herein collectively as “the virtual media devices 240” and individually as “the virtual media device 240”). The virtual media device 240 can be a virtual instance or representation of a hardware media device (such as, e.g., the audio device(s) 220, the imaging device(s) 219, or the like). The virtual media device 240 is a software application executable by the electronic processor 200. When the virtual media device 240 is executed by the electronic processor 200, the virtual media device 240 can perform at least one function similar to a corresponding hardware media device. As one non-limiting example, the virtual media device 240 can receive and output media signal(s), including, e.g., an audio data set or data stream, an image data set or data stream, or the like. The virtual media device 240 may also perform additional functionality, such as, e.g., controlling a media data set or data stream (a media signal) associated with a communication session. As described in greater detail herein, the virtual media device 240 may adjust a media signal (or media data stream) by adjusting a data element, removing a data element, adding a data element, or a combination thereof.

In the illustrated example, the virtual media devices 240 includes at least one virtual audio device 245 (referred to herein collectively as “the virtual audio devices 245” and individually as “the virtual audio device 245”) and at least one virtual imaging device 250 (referred to herein collectively as “the virtual imaging device 250” and individually as “the virtual imaging device 250”). The virtual audio device 245 (when executed by the electronic processor 200) can enable audio signals to be received, transmitted, or a combination thereof. Accordingly, the virtual audio device 245 can function similar to a hardware speaker (e.g., the speaker 221) by transmitting an audio signal, may function similar to a hardware microphone (e.g., the microphone 222) by receiving an audio signal, or a combination thereof.

As described in greater detail herein, the virtual media device(s) 240 (when executed by the electronic processor 200) can control, manipulate, or otherwise manage media signals. A media signal may include a media data set, a media data stream, or the like, where a media signal may include a set of (or a series of) data elements or portions. As one non-limiting example, the electronic processor 200 (via the virtual media device(s) 240) can enable the exchange of media signals across different communications platforms (e.g., communications platforms that would otherwise be incompatible with each other). As another non-limiting example, the electronic processor 200 (via the virtual media device(s) 240) can modify, supplement, cancel, augment, manipulate, or otherwise control a media signal (or a portion thereof).

As one non-limiting example, the virtual audio device 245 (when executed by the electronic processor 200) can receive multiple incoming audio signals, where at least one of the incoming audio signals is from a different communications platform than the remaining communications platforms. Following this non-limiting example, the virtual audio device 245 (when executed by the electronic processor 200) can combine (or merge) the incoming audio signals and provide the combined incoming audio signals (as a single audio signal) to the speaker 221 such that the speaker 221 outputs the single audio signal to a user of the user device 110. As another non-limiting example, the virtual imaging device 250 can receive an image data stream from the imaging device 219 and modify the image data stream prior to transmitting the image data stream to a remote device (such as another user device).

The memory 205 can include additional, different, or fewer components in different configurations. Alternatively, or in addition, in some configurations, one or more components of the memory 205 can be combined into a single component, distributed among multiple components, or the like. As one non-limiting example, in some configurations, the virtual media device(s) 240, the virtual identity 230, or a combination thereof can be included as part of the communication application 225. Alternatively, or in addition, in some configurations, one or more components of the memory 205 can be stored remotely from the user device 110, such as, e.g., in a remote database, a remote server (e.g., the server 115), another user device, an external storage device, or the like.

In other embodiments, the device 110, 115 can be a server 115 (referred to herein collectively as “the servers 115” and individually as “the server 115”). The server 115 may include a computing device, such as a server, a database, or the like. The server 115 may host or otherwise provide at least one communications platform. Accordingly, in some configurations, the server 115 is associated with a communications platform (e.g., included as a component, device, or subsystem of a system providing or hosting a communications platform or service). Alternatively, or in addition, in some instances, the server 115 can be associated with more than one communications platform or service. In other configurations, the user device 110 can include a communications platform to communicate with another communications platform(s) of other device(s). In the configurations, the server 115 can provide information (e.g., user verification information, communication approval, etc.) to the communications platforms to reduce network traffic to the server 115. As one non-limiting example, the server 115 can support a first communications platform and a second communications platform different from the first communications platform. Alternatively, or in addition, as noted above, in some configurations, the system 100 can include multiple servers 115. In such configurations, each server 115 can be associated with a specific communications platform. As one non-limiting example, a first server can be associated with a first communications platform, a second server can be associated with a second communications platform, and an n^{th} server can be associated with an n^{th} communications platform.

As illustrated in FIG. 2, the server 115 can include similar components as the user device 110, such as an electronic processor (for example, a microprocessor, an ASIC, or another suitable electronic device), a memory (for example, a non-transitory, computer-readable storage medium), a communication interface, such as a transceiver, for communicating over the communication network 130 and, optionally, one or more additional communication networks or connections, and one or more human machine interfaces. In some configurations, the functionality (or a portion thereof) as described as being performed by the server 115 can be locally performed by the user device 110. As one non-limiting example, in some configurations, the user device 110 can host or provide at least one communications platform. In such configurations, the server 115 can be eliminated from the system 100. Alternatively, or in addition, in some configurations, the server 115 can perform additional or different functionality than described herein. In some configurations, the functionality (or a portion thereof) as being performed by the user device 110 can be performed by the server 115. In such configurations, the server 115 may store at least one of, e.g., the communication application(s) 225, the virtual identity 230, the electronic file(s) 235, the virtual media device(s) 240, or a combination thereof.

Traditionally, within a window of a device, such as a computer or smartphone display, the device is typically configured to display a single layer of content at a time. For example, in a traditional electronic device, if a full-screen Microsoft® PowerPoint® (e.g., first layer) is being displayed on a device's window, that device cannot display a full-screen movie (e.g., second layer) without covering up the Microsoft® PowerPoint®. Accordingly, a user that has opened a full-screen movie atop a full-screen Microsoft® PowerPoint® would no longer be able to view the contents of the Microsoft® PowerPoint® without a) closing the full-screen movie or b) resizing and rearranging the Microsoft® PowerPoint® and movie such that each occupied separate, non-overlapping portions of the device's display.

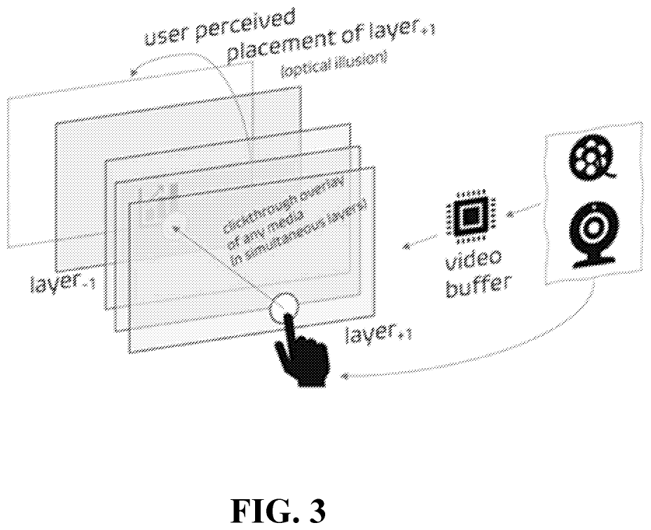

In comparison, the communications platform of the present disclosure enables managing, manipulating, and merging multiple layers of content into a single, augmented computing experience. FIG. 3 illustrates an example of such an augmented experience. As shown in FIG. 3, multiple layers of digital content from different input sources can be superimposed and displayed simultaneously to generate a composite, multi-layer arrangement of content within the viewing area of a display/screen (e.g., window). The superimposing can be performed such that the content from each of the input sources is simultaneously viewable—despite the content from the multiple input sources being superimposed relative to one another. This multi-layered viewability of content is achieved by adjusting the transparency of pixels within one or both layers to create a transparency effect so that both layers are visible. Accordingly, the multi-layer display would allow a user to, for example, view the content of a full-screen movie and a full-screen Microsoft® PowerPoint® simultaneously.

Moreover, the multi-layer display maintains the clickability of content within each layer, such that a user can access and control the digital content from each of the input sources. For example, where a first input source is a video conference feed and the second input source is a user's desktop GUI, the multi-layer display provided by the communications platform allows a user to see and talk to people via the displayed content from the video conference feed, while also allowing the user to open and control files (e.g., spreadsheets, slides, any suitable file) stored in the local memory of the user's computer and/or connect to the internet using the functionality provided by the user's desktop GUI. Additional details with regard to managing, manipulating, or merging multiple layers of content into a single window of a display to provide a multi-layered visual experience are described in a co-pending U.S. patent application Ser. No. 17/675,950 and U.S. Pat. No. 11,277,658, which are incorporated by reference herein in their entirety.

In the augmentation of a digital user experience that includes overlaying digital objects onto a viewable display area of a display to create a multi-layer display, certain regions—such as display objects, windows, or portions thereof—can be obscured by other display data. Overlaid digital objects can, if opaque to any degree, cause a partial obscuring or a loss of visual clarity for objects beneath. This can lead to a disadvantageous situation where content is not viewable to a necessary degree for a user.

One option for improving the ability to view content from each of the simultaneously displayed layers of a multi-layer display (such as, e.g., the multi-layer display of content provided by the communications platform) is by varying the transparency of the layers that are superimposed relative to one another to generate the multi-layer display. Specifically, by increasing the transparency of one or more (e.g., all of) the layers forming the multi-layer display relative to one another, the content from each of the layers may become more clearly visible. Additional details with regard to one option for selectively and dynamically varying the transparencies of the layers of a multi-layered display according to various example configurations are described in a co-pending U.S. Patent Application No. 63/406,574, titled “SYSTEMS AND METHODS FOR DYNAMICALLY CONTROLLING TRANSPARENCY ON A GRAPHICAL USER INTERFACE” which is incorporated by reference herein in its entirety.

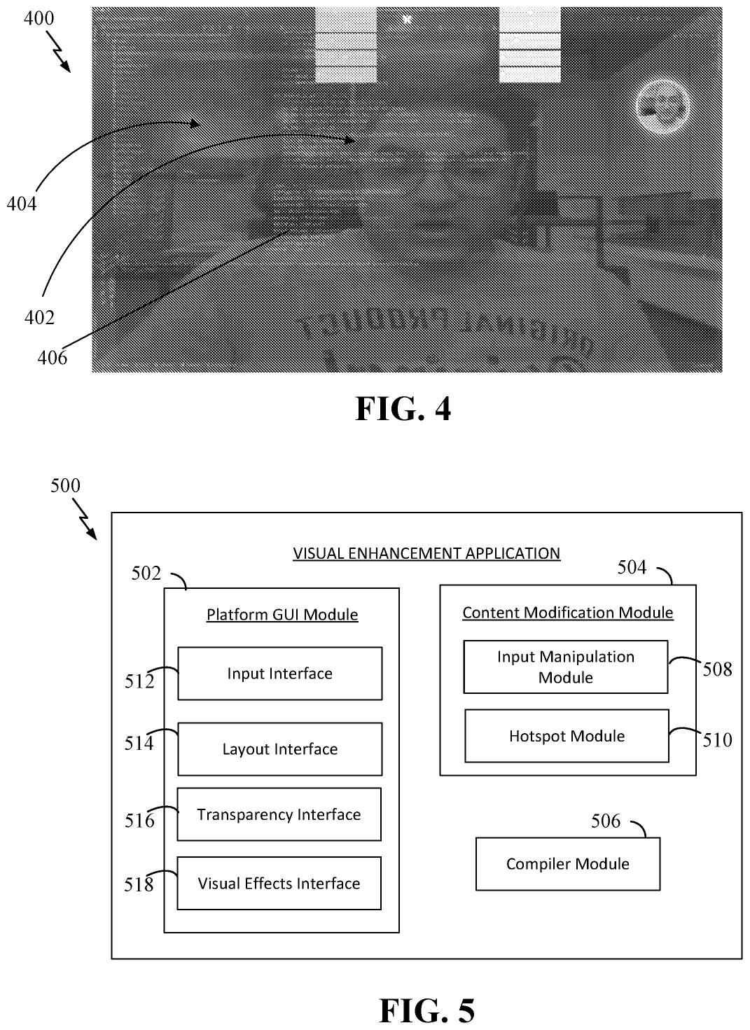

FIG. 4 is a schematic diagram conceptually illustrating an example multi-layer display 400 generated by the communications platform in which the transparencies of the layers of content have been varied to a desired degree by a user. In the multi-layer display 400 of FIG. 4, a first layer created from the content of a first input source (i.e., a video feed of the user 402) is superimposed over a second layer created from the content of a second input source (i.e., the user's desktop GUI 404). The use of the term layer refers to digital content displayed in a window of an electronic device. As one non-limiting example, the term layer may include digital content from an input source that is displayed in a window of device 110, 115 at a given point in time.

As illustrated by the example of FIG. 4, by varying the transparencies of each of the first layer and the second layer, the contents of both the video of the user 402 (i.e., the digital content of the first layer) and the image of the user's desktop GUI 404 (i.e., the digital content of the second layer) are made easily discernable (i.e., the viewer is easily able to generally see) to a user—despite their superimposed (i.e., overlaid) arrangement relative to one another.

However, relying solely on varying transparency levels may not always be sufficient to provide a user with a desired degree of discernability (e.g., readability) of the contents displayed by a multi-layer display. For example, increasing the visibility of the contents of a first layer by increasing the transparency of a second layer may come at the cost of being able to view the contents of the second layer. Also, variables such as, e.g., the lack of contrast, blurring, differences in color pallets, etc., between the overlaid (i.e., superimposed) contents of the multi-layer display may hinder the readability of the contents of the superimposed layers. This can be particularly troublesome for users with certain health conditions such as poor eyesight, dyslexia, colorblindness, attention disorders, and the like.

For example, as illustrated by the multi-layer display of FIG. 4, modifying the transparency values of different input layers may be sufficient to render some content (such as e.g., the image of a user from a video feed 402) within the multi-layer display 400 sufficiently clear and discernable to a user, while failing to provide other content (such as, e.g., the text 406 displayed on the user's desktop GUI 404) with the requisite clarity and vividness needed to also be clearly viewed and understood by a user.

In view of the foregoing, described with reference to FIGS. 5-15B are examples of a visual enhancement application 500 and methods of its use that advantageously enhance the ability of a user to view content clearly and vividly from multiple input layers simultaneously via a multi-layer display. In some examples, the visual enhancement application 500 is provided as a part of the communication application 225 (as an integrated part of the software of the communication application 225 and/or as an add-in used in conjunction with the communication application 225), providing an enhanced communication application that enables user interaction with a communication platform (e.g., ECP). Similar to the discussion of the communication application 225 with reference to FIGS. 1 and 2 above, in some examples the enhanced communication application may be provided as a CPaaS (e.g., as a browser application) that that enables access and interaction with a communications platform, such as, e.g., a communications platform associated with the server 115. Alternatively, or in addition, the enhanced communication application may be a dedicated software application that enables access and interaction with a communications platform, such as, e.g., a communications platform associated with the server 115. In such examples where the visual enhancement application 500 is provided as part of an enhanced communication application, the visual enhancement application 500 is used to simultaneously display video feed from a communication session provided by the communication application 225 in an overlaid arrangement with content from one or more other input sources (e.g., a feed of the user's desktop GUI) in a manner that enhances the ability of a user to view and interact with content on the user's desktop GUI while simultaneously viewing the communication session video feed.

As will be appreciated, in other examples the visual enhancement application 500 may alternatively be used to display content from any number of other input sources. In other words, in various examples the visual enhancement application 500 may be used to display a multi-layer arrangement of data from input sources other than a conferencing program (such as, e.g., the communications application 225) or a feed of a user's desktop GUI. Accordingly, instead of (or in addition to) providing the visual enhancement application 500 as part of the user device/server 110/115 described herein, the visual enhancement application 500 may alternatively: be provided as part of any number of other software applications/programs; stored in the memory of any number of other user devices; be provided as a SaaS (e.g., may be a browser/web-based program); be embodied on standalone software or other standalone computer-readable media; etc. For example, the visual enhancement application 500 may be used to enhance a user's ability to view (and thus interact with) the contents of two distinct programs running off a user's computer. As one non-limiting example, the visual enhancement application 500 may be used to enhance the viewability of the contents of a multi-layer display generated based on the superimposed arrangement of the digital content of a spreadsheet program (i.e., a first input source) relative to the content obtained from a web-browser (i.e., a second input source).

As illustrated by FIG. 5, the visual enhancement application 500 generally includes a platform GUI module 502, a content modification module 504, and a compiler module 506. The function and operation of the components of the visual enhancement application 500 are described in more detail below.

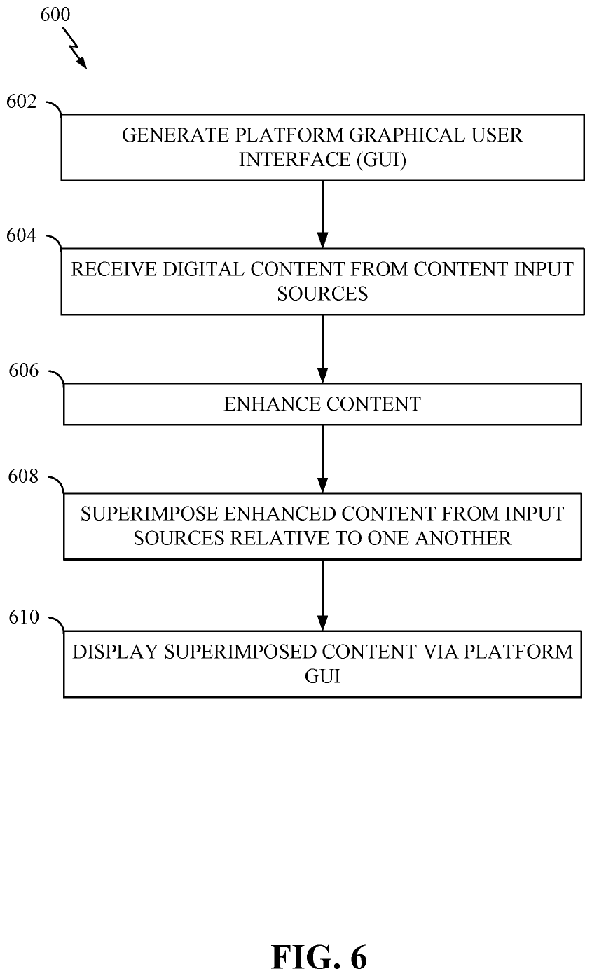

FIG. 6 is a flowchart illustrating an example method and technique utilized by the visual enhancement application 500 for enhancing the visibility, readability, and understandability of content from two or more content input sources that is overlaid and simultaneously displayed within a single display area. In some examples, the process 600 may be carried out by a device (e.g., the server(s) 115 and/or the user device(s) 110 illustrated in FIGS. 1 and 2), e.g., employing circuitry and/or software configured according to the block diagram illustrated in FIG. 2. In some examples, the process 600 may be carried out by any suitable apparatus or means for carrying out the functions or algorithm described herein. In some examples, any systems and/or display devices are used to implement the flowchart 600. Additionally, although the blocks of the flowchart 600 are presented in a sequential manner, in some examples, one or more of the blocks may be performed in a different order than presented, in parallel with another block, or bypassed.

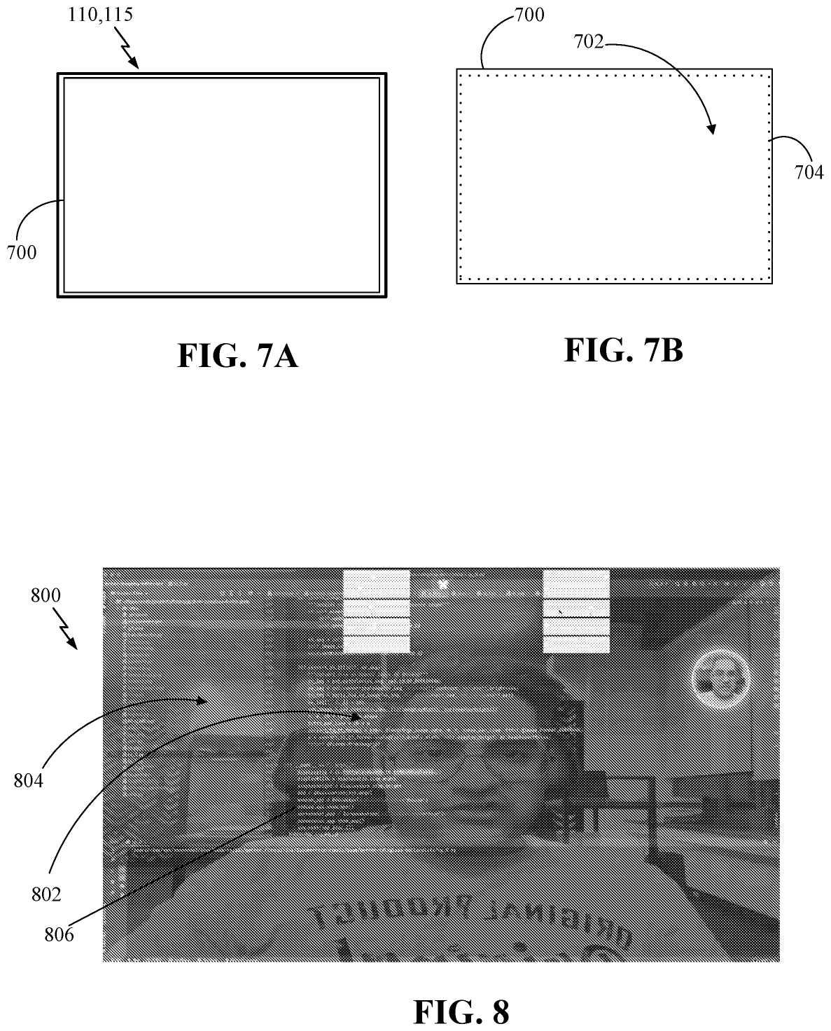

At block 602, the platform GUI module 502 of the visual enhancement application 500 causes a platform GUI to be generated over an existing GUI of a device (e.g., one or more of the servers 115, also referred to as the server 115 or one or more user devices 110, also referred to as the user device 110). FIG. 7A is a schematic diagram conceptually illustrating an example platform GUI 700 that is generated and displayed within a display area of a display of a device (e.g., user device 110, 115) during block 602. The display within which the platform GUI is displayed may be a display of a mobile device such as a smartphone, tablet, and the like, a display of a desktop computer, or another interactive display. In some examples, the user device 110 can generate the platform GUI on the user device 110 based on instructions stored in the memory. In other examples, the server 115 can generate, for display on a user device for a user, the platform GUI and transmit the platform GUI to the user device via the communication network. In further examples, the device (e.g., the server 115 or the user device 110) can generate a platform GUI using the communications platform described above.

As illustrated by the schematic diagram of FIG. 7B, the platform GUI 700 defines a projector area 702 that is defined by the outer perimeter 704 of the platform GUI 700. The projector area 702 defines an area within which content can be displayed by the platform GUI 700. Although the platform GUI 700 is shown as being rectangular in shape, the platform GUI 700 may be defined by any other number of other shapes.

At block 604, the visual enhancement application 500 receives digital content from multiple input sources. As discussed above, the visual enhancement application 500 may be used with the communications application 225 and/or with any number of other programs. Accordingly, the input sources from which content is received may include a variety of sources—non-limiting examples of which include: a video conferencing program (e.g., the communications application 225), software or other content (e.g., programs, files, etc.) stored in the memory of, or otherwise running on, the user device 110, 115 or other user device; a user's desktop GUI (e.g., operating system software such as Microsoft® Windows®, macOS®, Android®, or any other suitable operating system software); a video player, an external camera; a live broadcast, etc.

The digital content obtained from the input sources may include any combination of one or more: pictures, numbers, letters, symbols, icons, videos, graphs, and/or any other suitable data. The content can include different file formats and/or different applications. The content can include any suitable data stored in a memory of the device 110, 115 or received from the communication network. For example, the content can include a stream of data being outputted by a video or graphics card and onto a display of the user device 110, 115. Content may include both dynamic content (e.g., a video stream), as well as static content (e.g., a text document). In some examples, the digital content may include interactive or otherwise engageable components (e.g., a search bar, hyperlinks, user-selectable icons, etc.) that the user may interact with.

At block 606, the visual enhancement application 500 enhances the content received from the input sources using one—or both—of the input manipulation module 508 and the hotspot module 510 of the content modification module 504. At block 608 the compiler module 506 superimposes the enhanced content generated by the content modification module 504 into a multi-layered array, which is displayed at block 610 within the platform GUI 700 generated by the platform GUI module 502.

As described in more detail below, the input manipulation module 508 and hotspot module 510 provide the content modification module 504 with two distinct options via which the content modification module 504 may enhance content at block 606 in order to enhance the ability of a user to view and understand content in a multi-layer display. In general, according to a first option, the content modification module 504 uses the input manipulation module 508 to enhance content visibility by modifying one or more visual (i.e., image variable) parameters of the content received from input sources to generate modified output layers. Non-limiting examples of image variable content parameters that may be modified by the input manipulation module 508 include: hue, saturation, brightness, transparency, contrast, color map, blur, sharpness, etc.

The input manipulation module 508 modifies the visual parameters of the content from each of the input sources in accordance with an enhancement profile. The enhancement profile applied to each input source is tailored to: a) the specific type of content (e.g., text, image, video feed, etc.) from the particular input source to which the enhancement profile is to be applied, as well as b) the overall types of content from each of the other input sources that will be displayed in a superimposed arrangement within the platform GUI 700.

The resultant modified output layers (i.e., the output layers generated by applying enhancement profiles to the contents of each of the received input sources) are each configured to increase the clarity and vividness with which the contents from each of the different input sources are viewable by a user once the output layers are displayed in a superimposed, multi-layer arrangement relative to one another. In such a manner, the input manipulation module 508 allows content within the multi-layer display to be much more easily read and understood by a user than would be possible by superimposing the original (i.e., unmodified) content from the input sources relative to one another.

FIG. 8 a is a schematic diagram conceptually illustrating an example multi-layer display 800 that is generated in-part in a manner similar to that described with reference to the multi-layer display 400 of FIG. 4. Specifically, the multi-layer 800 of FIG. 8 is generated based on the same content from the same first and second input sources (i.e., a video feed of the user 802 and the user' desktop GUI 804, respectively) as those used to generate the multi-layer display 400 of FIG. 4. Additionally, in generating the multi-layer display 800 of FIG. 8, the transparencies of the digital contents of each of the first and second input sources are set to the same transparency levels as those used in displaying the contents of the first and second input sources in the multi-layer display 400 of FIG. 4.

However, unlike the multi-layer display 400 of FIG. 4, the multi-layer display 800 of FIG. 8 is generated using a visual enhancement application 500 as described herein—and in particular, using an input manipulation module 508 of the visual enhancement application 500. Thus, as described above, the modified output layers used to generate the multi-layer display 800 correspond to versions of the content from the first and second input sources that have been modified by the input manipulation module 508 in a manner to increase the clarity and vividness of the content of each of the first and second input sources upon their being superimposed relative to one another.

Accordingly—as illustrated by the comparison of the multi-layer displays of FIG. 4 and FIG. 8—the discernability of the content provided by the multi-layer display 800 is enhanced as compared to that provided by the multi-layer display 400 of FIG. 4. In particular, in the multi-layer display 800 of FIG. 8, the readability and visibility of the content (i.e., text 806 on the user's desktop GUI 804) of the second layer is enhanced—thereby allowing a user to more easily read or view the contents displayed within the platform GUI 700—without sacrificing the visibility and clarity of the content (i.e., the video feed of user 802) of the first layer.

The second option via which the content modification module 504 is configured to enhance the viewability of overlaid content within a multi-layer display at block 606 in the flowchart of FIG. 6 is by generating—using the hotspot module 510—one or more hotspot layers that selectively highlight certain content within the multi-layer display in response to the detection of a predetermined threshold. As discussed in more detail below, the hotspot module 510 generates a hotspot layer for each region of interest (i.e., hotspot) identified within a layer of content. For each generated hotspot layer, a highlight profile is assigned by the hotspot module 510 to the portion(s) of the hotspot layer corresponding to the location of the hotspot(s) relative to the other content (i.e., non-hotspot content) of the layer. When viewing the contents of the multi-layer display, a user is able to enhance the visibility of content within each hotspot by triggering a predetermined visual modification threshold. Upon detecting that the threshold has been met, the hotspot module operates to apply the hotspot layer to the content of the input source, causing the hotspot to be visually modified by the applied hotspot layer in a manner that makes the content of the hotspot readily understandable by a user.

For example, in response to detecting that a cursor has been positioned atop the hotspot (i.e., upon detection that a predetermined visual modification threshold for the hotspot has been met), the applied hotspot layer causes the transparency of the hotspot to be significantly (e.g., entirely) reduced, and thereby increases the opacity (and, in turn, the readability) of the content in the designated hotspot. In some examples, additional visual modifications (e.g., providing a 3D effect, enlargement of the hotspot relative to surrounding content, etc.) may optionally also be provided by the highlighting applied by the hotspot layer to further enhance viewability of the hotspot.

As noted above, in some examples the content modification module 504 optionally includes only one of the input manipulation module 508 and hotspot module 510. However, given the varying manners in which the input manipulation module 508 and hotspot module 510 operate to enhance the viewability and comprehensibility of content within a multi-layer display, in various examples the content modification module 504 advantageously utilizes and leverages the distinct advantages provided by each of the input manipulation module 508 and hotspot module 510 in enhancing the visibility of content displayed by a multi-layer display.

As described above, by modifying the overall clarity and vividness with which the content from multiple input sources in displayed, the input manipulation module 508 advantageously allows a user to simultaneously appreciate and visualize—within a single, overlaid display area—the entirety of the contents presented by multiple input sources. However, as will be appreciated, there may be scenarios where even the enhanced viewability of overlaid content provided by the input manipulation module 508 may not be sufficient to render superimposed content sufficiently clear and understandable to a high enough degree desired by a user. In such situations, the ability of hotspot module to selectively and dynamically highlight areas of interest within the content of the multi-layer display in a manner that specifically emphasizes the content of the hotspot thus provides a user with a targeted solution via which the user can access and more closely inspect selected important content within the multi-layer display on an as-needed basis. Configurations of the visual enhancement application 500 that operate using both the input manipulation module 508 and the hotspot module 510 thus advantageously combine the improved holistic viewing experience provided by the input manipulation module with the improved targeted and focused viewing experience provided by the hotspot module into a single, seamless use viewing experience.

According to some examples, the visual enhancement application 500 operates in a predefined, default mode in performing the various steps of the process 600 for enhancing the visibility, readability, and understandability of content displayed in a multi-layer arrangement within the platform GUI 700. In one non-limiting example the visual enhancement application 500 operates according to a default setting to enhance the viewability of content in a multi-layer display during use of the communication application 225. In this example, at block 604 the visual enhancement application 500 receives content from predefined, default input sources corresponding to: a) a video feed of a communications session received from the communication application 225, and b) an input of the user's desktop GUI. At block 610, the visual enhancement application 500 displays the enhanced content from each of the input sources (i.e., from the video feed of the communications session and the feed from the user's desktop GUI) across the entirety of a projector area 702 defined by the platform GUI 700 in accordance with a preset, default content layout setting.

As will be appreciated, instead of relying on default settings, a user may alternatively wish to customize one or more aspects related to the selection of content displayed and/or manner via which content is displayed within the platform GUI 700. In yet other non-limiting examples, a user may wish to apply additional visual effects to the content displayed by the platform GUI. As described in detail below, these additional visual effects refer to visual modifications other than those modifications that are made by the content modification module 504 to enhance the clarity and vividness of the content being displayed.

Accordingly, as shown in FIG. 5, in various examples the platform GUI module 502 advantageously includes one or more user-input settings interfaces (e.g., an input interface 512, layout interface 514, a transparency interface 516 and/or a visual effects interface 518) via which a user can customize the manner in which content is displayed by the platform GUI. In such visual enhancement application 500 examples (i.e., in embodiments in which the platform GUI module 502 includes one more settings interfaces), at block 602 the step of generating a platform GUI thus additionally includes generating and displaying, within the platform GUI, one or more settings interface GUIs via which a user can input desired settings into the corresponding settings interfaces.

As will be appreciated, in some examples a single settings interface GUI generated at block 602 may allow a user to selectively modify settings related to multiple parameters (e.g., a single interface GUI may allow a user to both select input sources, as well as modify the relative arrangement of content within the projector area 702 defined by the platform GUI 700). Alternatively, separate interface GUIs may be generated by the platform GUI module at block 604 for each display parameter (e.g., a first interface GUI may be generated via which a user can select input sources, a second interface GUI may be generated via which a user can select a desired visual effect, etc.).

Referring again to FIG. 5, according to some examples the platform GUI module 502 includes an optional input interface 512 via which a user (or non-human) may designate one or more input sources from which digital content is to be received to generate the multi-layer arrangement displayed within the platform GUI 700. The platform GUI module 502 optionally further includes a layout interface 514 via which a user may selectively modify the manner by which content from different input sources is to be displayed within the projector area 702 defined by the platform GUI 700. Specifically, for each input source, the layout interface 514 provides the user with the ability to assign the content from each input source into one or more containers via which the content will be displayed within the projector area 702. For each container, the layout interface provides the user with the ability to modify: the relative shape of the container, the relative size of the container (e.g., as corresponding to the entirety of the projector area 702 or only a portion therefor), and/or the position of the container relative to the projector area 702 of the platform GUI 700.

The optional transparency interface 516 provided by the platform GUI module 502 allows a user to selectively control the degree to which she wishes to see the layers that comprise a multi-layer display. Additional details with regard to one non-limiting example of a transparency interface 516 are described in a co-pending U.S. Patent Application No. 63/406,574, titled “SYSTEMS AND METHODS FOR DYNAMICALLY CONTROLLING TRANSPARENCY ON A GRAPHICAL USER INTERFACE” which is incorporated by reference herein in its entirety. In some examples, in addition to (or, alternatively, in place of) allowing a user to selectively and dynamically adjust the transparency levels of the content of each of the input sources, the transparency interface 516 may also (or, alternatively, the transparency interface 516 may instead) allow a user to selectively and dynamically adjust one or more other visual (i.e., image variable) parameters (such as, e.g., hue, saturation, brightness, transparency contrast, color map, blur, sharpness, etc.) of the content of each of the input sources.

As described above, the visual enhancement application 500 operates by visually modifying content received from input sources using one or both of an input manipulation module 508 and/or hotspot module 510 so as to enable a user to more clearly and readily discern the content that is displayed in a multi-layer display. In addition to the content modification provided by the content modification module 504 to enhance the visibility of the content displayed by the multi-layer display, in some examples a user may further desire that the visual enhancement application 500 visually modify the content from the input sources to also achieve a desired visual effect when displaying content in the platform GUI 700. Thus, as shown in FIG. 5, the platform GUI module 502 of the visual enhancement application 500 includes an optional visual effect interface 518 via which a user may select an enhancement visual effect setting that is to be applied to the content as part of the step of displaying superimposed content at block 610 of the process described with reference to FIG. 6.

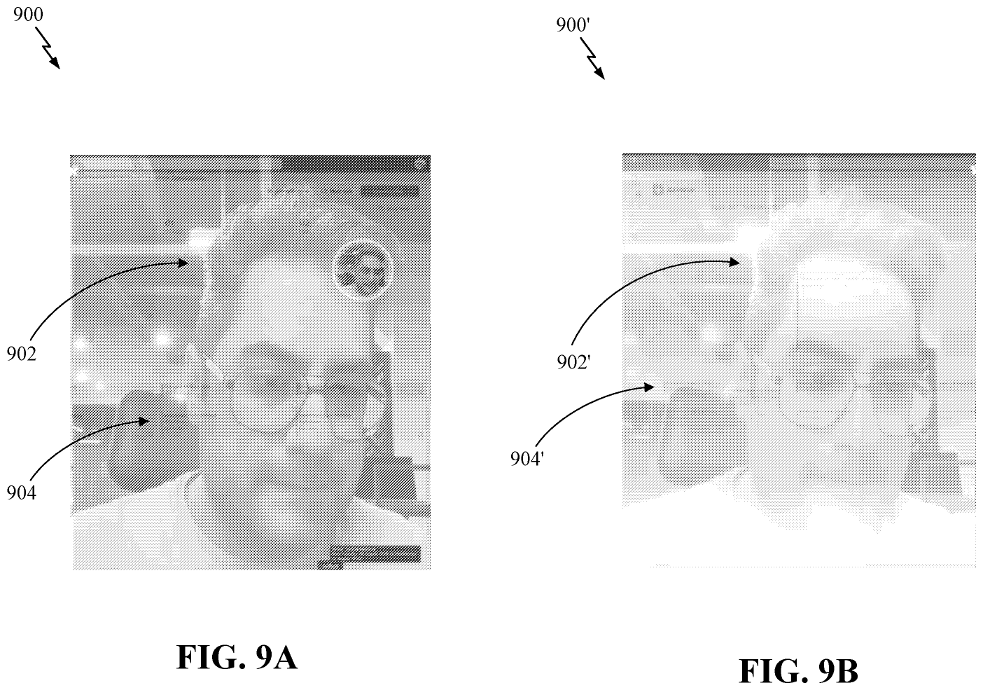

In some examples, the desired enhancement visual effect setting selected by a user may be a desired color palette that is to be applied to the content displayed in the platform GUI 700. For example, shown in FIG. 9A is a schematic diagram conceptually illustrating a multi-layer display 900 generated by the visual enhancement application 500. In the example multi-layer display 900 of FIG. 9A, the visual enhancement application 500 is being used by a user to simultaneously view content from a video feed 902 of a communications session (such as, e.g., as provided by the communications application 225) as well as content from a personal calendar 904 displayed by a feed from the user's desktop GUI.

Continuing with the example described with reference to FIG. 9A, the user (or non-human) may be utilizing the visual enhancement application 500 while on a conference call discussing the planning of an upcoming party. Accordingly, in this example, the user may desire the overall feel provided by the multi-layer display 900 to match the festive context of the meeting. Thus, the user may select—via the visual effect interface 518—an enhancement visual effect setting corresponding to a colorful, bold color palette that is to be applied to the content multi-layer display. The result of the application of this selected color palette enhancement visual effect is illustrated by the multi-layer display 900′ of FIG. 9B. Because the visual modification applied to the multi-layer display based on the selected visual effect setting is provided in addition to the modification of content provided by the content modification module 504, the resulting multi-layer display 900′ also displays content with sufficient clarity and vividness to allow the user to readily discern its content.

In some examples, the enhancement visual effect setting selected by a user via the visual effects interface 518 may be a color palette selection that makes viewing content easier (e.g., less straining) for a color-blind and/or color-sensitive user. In another non-limiting example, an enhancement visual effect setting may be used to provide the multi-layer arranged content displayed in the platform GUI the visual effect of being displayed on a lightboard.

Instead of the user input being an input that is directly provided by a user into any of the settings interfaces described herein (e.g. the input interface 512, layout interface 514, transparency interface 516, visual effects interface 518, hotspot interface discussed below, etc.), in some non-limiting examples the user input may alternatively (or additionally) be generated by a non-human, such as a robotic arm or by signals received from an image capturing device (e.g., digital camera) that represents the movement or haptics of a user. In some such examples the non-human input may act solely as a conduit via which a decision made by a user is input into the settings interface. In other such examples, the non-human input may instead (or additionally) be based on input from an artificial intelligence (AI) program, and may thus not require any direct input from the user.

As one non-limiting example, although the enhancement visual effect setting is described as being applied responsive to a user selection input via the visual effects interface 518, the selection of a visual effect setting that is to be applied to the contents of the multi-layer display may instead (or additionally) be based on input from an AI program. For example, referring to the scenario described with reference to FIGS. 9A and 9B, AI analysis of the content from the input sources (i.e., the video conferencing feed and/or based on the user's desktop GUI) may determine the party-planning related and/or otherwise festive nature of the conference call, and using this determination may automatically apply a bold, colorful color palette to match the context of the conference call.

As another non-limiting example, upon detecting that the contents from the input sources include images that are known to typically be rendered in a certain color schema (e.g., images from a medical imaging procedure, architectural drawings, CAD files, etc.), the AI may automatically apply a complimentary color palette schema to the multi-layer display so as to make it easier for the user viewing the images to clearly discern their contents.

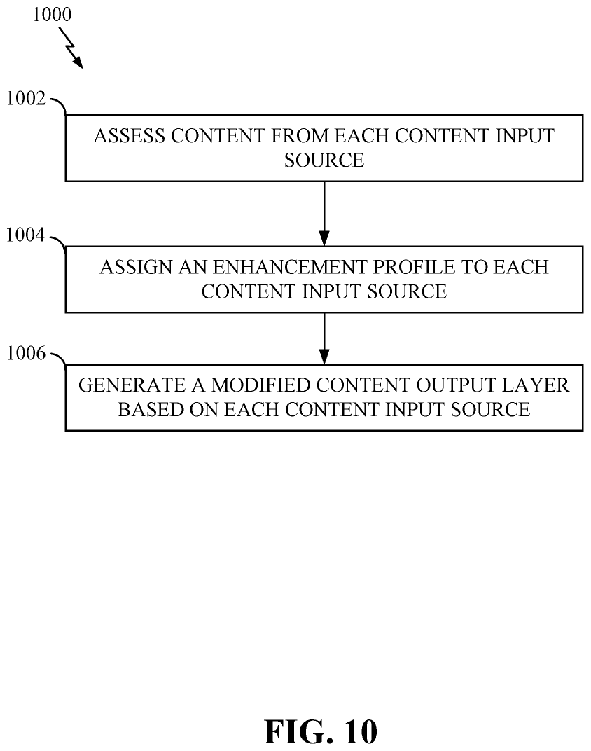

FIG. 10 is a flowchart illustrating an example method and technique utilized by the content modification module 504 at block 606 of the process 600 of FIG. 6 for enhancing the visibility, readability, and understandability of content from two or more content input sources that are overlaid and simultaneously displayed in a multi-layer arrangement within the platform GUI 700. In particular, the process 1000 of FIG. 10 describes a process in which the content modification module 504 utilizes the input manipulation module 508 to achieve the desired content modification.

In general, the input manipulation module 508 modifies content by modifying one or more visual (i.e., image variable) parameters of the content received from input sources to generate modified output layers. Non-limiting examples of image variable parameters that may be modified by the input manipulation module 508 include: hue, saturation, brightness, transparency, contrast, color map, blur, sharpness, etc. The content of each input source is modified based on instructions corresponding to an enhancement profile assigned by the input manipulation module 508 to each input stream. The enhancement profile is assigned based on an input source profile assigned to the input source based on an assessment of the input source by the input manipulation module.

At block 1002, the input manipulation module 508 assesses content from each content input source and—based on this assessment—assigns, for each input source an input source profile. In assigning an input source profile to each input source, the input manipulation module assesses the overall type of content from all of the input sources that is to be used to generate the multi-layer display, as well as the specific contents of each input source. In examples in which the visual enhancement application 500 allows a user (or, e.g., AI) to input desired selections using one or both of the transparency interface 516 and/or visual effects interface 518, the input source profile assigned to each input source may additionally base the input source profile assigned to each input source in part on these additional user input selections.

The input manipulation module 508 can assess the overall type of content of the input sources using a number of different options. In some configurations, the type of content can be determined by inspecting the main memory of the user device/server 110/115 to identify what is being displayed by each application, program, or window open on the user device and/or by inspecting any metadata in the feed from the input sources. Based on the type of program from which the content is being received the input manipulation module 508 may generalize the type of content likely to be included in the stream from that input source. For example, based on identifying that a first input source is an input stream from Microsoft® PowerPoint® and the second input stream is from a communications session (e.g., a provided by communications application 225), the input manipulation module 508 may identify the first input source as providing a mix of image and text content, and the second input source as provide video content.

In order to provide a more specific assessment of the actual content being received from the input source, in some examples the input manipulation module may advantageously inspect the streams of data being input from each of the input sources using computer vision, including, but not limited to, image recognition, semantic segmentation, edge detection, pattern detection, object detection, image classification, and/or feature recognition. Examples of artificial intelligence computing systems and techniques used for computer vision include, but are not limited to, artificial neural networks (ANNs), generative adversarial networks (GANs), convolutional neural networks (CNNs), thresholding, and support vector machines (SVMs).

In such examples, the use of computer vision may allow the input manipulation module to provide a more granularized assessment of the input sources. For example, instead of generally identifying an input stream from Microsoft® PowerPoint® as corresponding to a mix of image and text content, the use of computer vision may allow the input manipulation module to more specifically identify the input stream as corresponding to a mix of 70% text and 30% image. In some examples, the use of computer vision may additionally allow the input manipulation module 508 to further granularize its assessment of an input stream by assigning different input profiles to different portions of the contents of the input stream.

In some examples, in addition to using computer vision to assist with a content-based assessment of the input sources in assigning an input profile, the input manipulation module may also advantageously use computer vision to assess a color profile of the contents of the input sources, which may further help improve the specificity with which the input manipulation module 508 can assign an input profile to each input source. At block 1004, the input manipulation module assigns an enhancement profile to each input source based on the input profile assigned to each input source. Each enhancement profile identifies: what visual parameters in the input stream of the content are to be modified, the specific modifications to the variables that are to be applied, and any special instructions related to the manner in which the modifications are to be applied to generate the resultant modified output layer for each input source.

As noted above, image variable parameters that may be modified include one or more of: hue, saturation, brightness, transparency, contrast, color map, blur, sharpness, etc. The specific modifications that are to be applied may include instructions relating to, e.g., a specific, preset value for each parameter that is to be attained, may refer to a change that is to be applied relative to the original parameter value (e.g., an instruction that saturation is to be increased by 25%), etc. In some examples, the special instructions may identify that the relative color shift between pixels is to remains the same in the output layer (as compared to that in the original input source) in order to maintain crispness and contrast between distinct objects. As another example, the special instructions may identify different parameter modifications that are to apply to different portions of the content.

In some examples, the special instructions may require that duplicate layers be generated from the content of an input source, with the instructions for the enhancement profile further specifying different image variable modifications that are to be applied to each of the individual duplicate layers. Upon applying these modifications, the duplicate layers are compiled together to define the output layer.

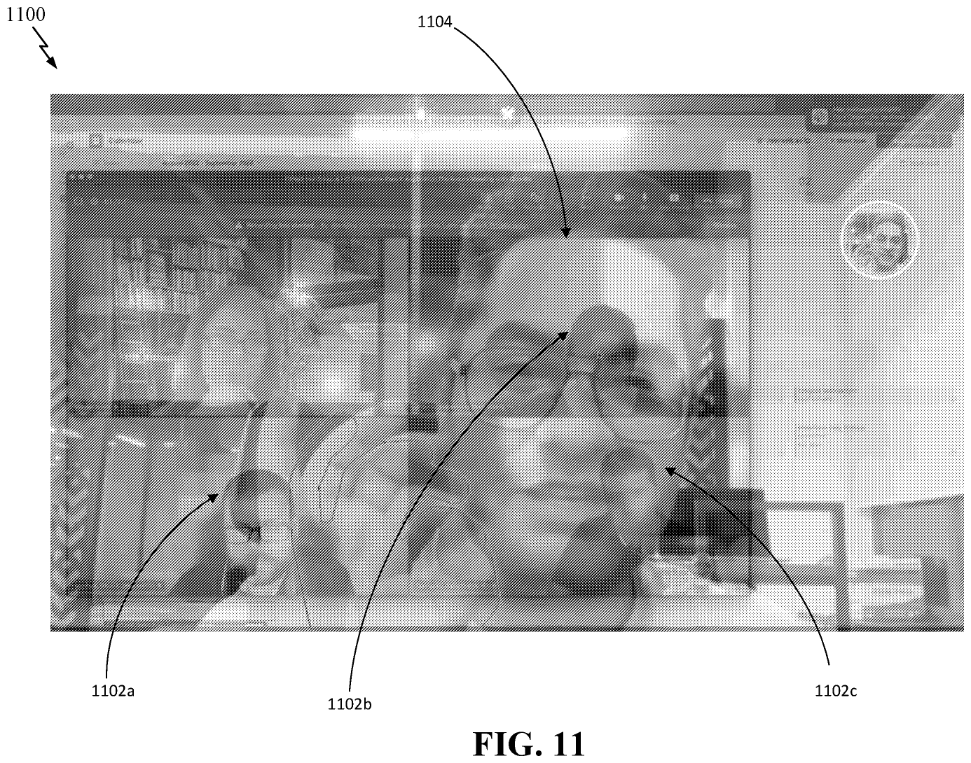

For example, in order to provide increased clarity when displaying content that is overlaid onto the images of individuals (e.g., as received from a conferencing session video feed), the special instructions may indicate that in a first duplicate layer, the blur of the duplicate layer is to be modified by a predetermined degree, while in a second duplicate layer contrast and transparency are to be modified by predetermined amounts. The multi-layer display 1100 of FIG. 11—generated by using the visual enhancement application 500 to simultaneously display the contents of a video feed of a user and a video feed of a conferencing session—illustrates the clarity with which superimposed image of the user 1104 and those of the participants 1102a, 1102b, 1102c of the videoconference can be viewed relative to one another thanks to the modifications provided by the input manipulation module 508 described herein.

In some examples, the enhancement profile corresponds to a preconfigured set of instructions that are stored in an enhancement content database provided by (or otherwise made accessible to) the input manipulation module 508. Each stored enhancement profile corresponds to (i.e., is associated with) an input source profile. Accordingly, at block 1004, assigning an enhancement profile may simply involve retrieving, from the enhancement content database, the corresponding set of instructions stored for the input source profile assigned to the input source at block 1002.

As discussed above, in some examples computer vision may be utilized by the input manipulation module 508 to inspect the streams of data being input from each of the input sources to determine the type of content within the stream from each input source, and thereby assist in assigning an input source profile to each input source. In some examples, the analysis of the stream of data input from an input source by the computer vision may further also be utilized by the input manipulation module 508 to additionally also to identify an enhancement profile based on its assessment of the contents within the input source.

At block 1006, the input manipulation module generates the modified output layer for each input source. As will be appreciated, in embodiments in which an enhancement profile includes instructions that require that the generation, and subsequent modification, of duplicate layers of the content of an input source, the process at block 1006 may include the step of compiling these duplicate layers together to define the modified output layer. The output layers generated at block 1006 for each of the input sources are then superimposed relative to one another (and further processed) in accordance with the description related to block 608 discussed above with reference to FIG. 6.

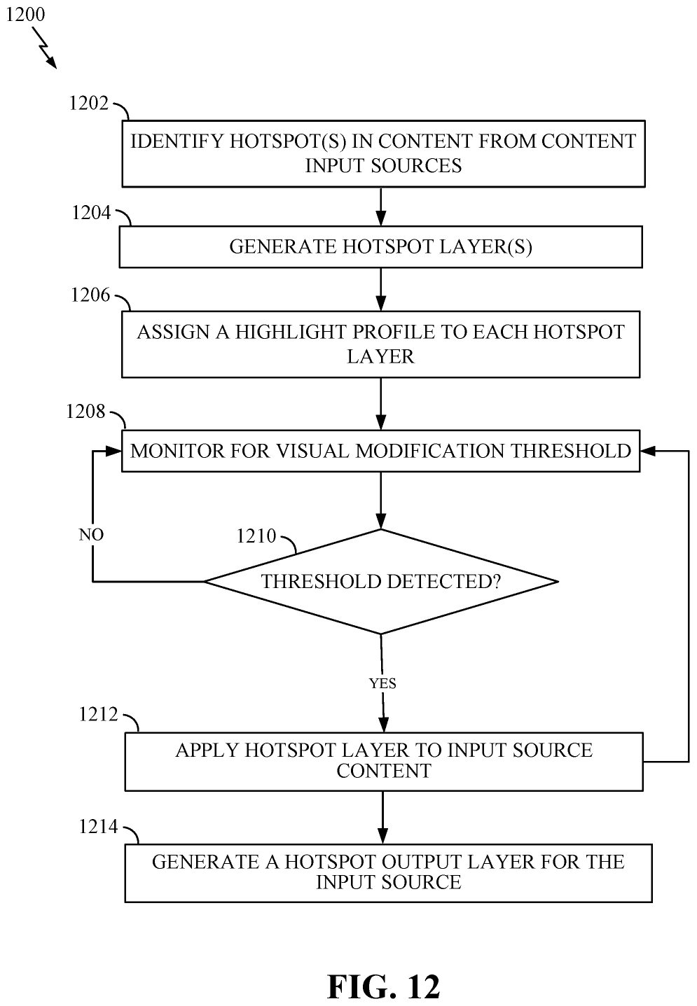

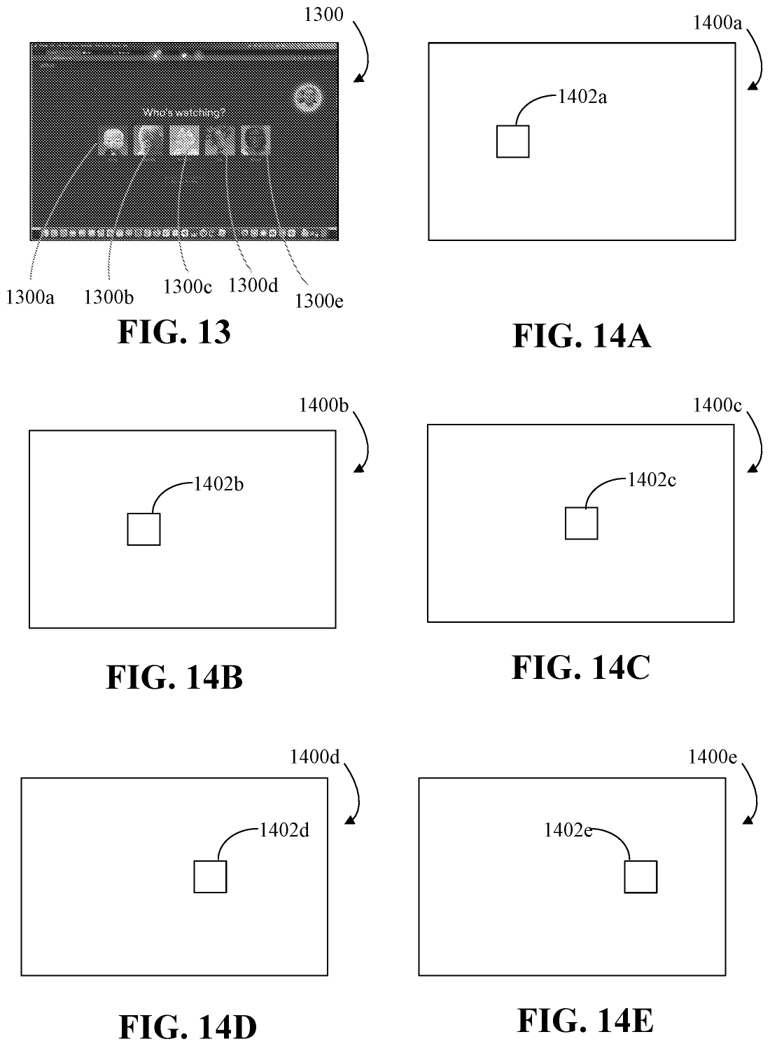

FIG. 12 is a flowchart illustrating an example method and technique utilized by the visual enhancement application 500 that may be utilized by a hotspot module 510 of the content modification module 504 at block 606 of the process 600 of FIG. 6 for enhancing the visibility, readability, and understandability of content from two or more content input sources that are overlaid and simultaneously displayed in a multi-layer arrangement within the platform GUI 700. At block 1202, the hotspot module 510 identifies one or more areas of interest (i.e., hotspots) within the contents of the input sources that are to be used to generate a multi-layer display. FIG. 13 is a schematic diagram conceptually illustrating a webpage displayed in a web-browser running on the user's desktop GUI. In an example where the user's desktop of FIG. 13 has been designated a first content input source, the hotspot module may, for example, identify objects 1300a-1300e as potential areas of interest, and designate each of these objects as hotspots. by the visual enhancement application 500. In various configurations, the hotspots in an input source (e.g., hotspots 1300a-1300e in FIG. 13) may be detected automatically by the hotspot module. Additional details with regard to systems and methods via which hotspots can be detected are described in a co-pending U.S. Patent Application No. 63/407,489, titled “APPLYING VISUAL MODIFIERS TO OBJECTS OF INTEREST SELECTED BY A POINTER FROM A VIDEO FEED IN A FRAME BUFFER VIA PROCESSING CIRCUITRY” which is incorporated by reference herein in its entirety.

Alternatively, or additionally, the hotspots can be user (or non-human) selected. For example, a hotspot interface provided by the hotspot module 510 may allow a user to select (e.g., draw an outline around) one or more sections of content that is to be designated as a hotspot. In examples in which hotspots are additionally detected automatically, the hotspot interface may additionally allow a user to deselect areas automatically designated as hotspots by the hotspot module 510. In some examples, the hotspot module 510 optionally provides a user the ability to designate separate, discrete portions of the content from an input source as together defining a single hotspot. For example, referring to FIG. 13, a user may designate objects 1300a and 1300e as defining a single hotspot.

At block 1204, hotspot layers are generated by the hotspot module 510 for each identified hotspot. As illustrated by the example schematic diagrams of FIGS. 14A-14E, in generating each hotspot layer (e.g., 1400a-1400e), for each hotspot layer, the hotspot module 510 identifies the location, position and sizing of the hotspot 1402a-1402e relative to the other content from the input source. Accordingly, when the hotspot layer is applied at block 1212 (discussed below) to the content of the input source, the highlighting applied by the hotspot layer is appropriately limited to the portion(s) of the original content designated as the hotspot.

At block 1206, a highlight profile is assigned to each hotspot layer. In particular, the highlight profile is assigned to portions of the hotspot layer based on the portions of the hotspot layer identified at block 1204 as corresponding to the location of the hotspot. In such a manner, upon being applied to the content of the input source at block 1212, the highlighting provided by the hotspot layer is limited to modifying only those portions of the content of the input source designated as being relevant to the hotspot.

The highlight profile defines the type of highlighting that will be provided by the hotspot layer to the hotspot upon detection of visual modification threshold (discussed below). Additionally, the highlight profile identifies a predetermined visual modification threshold that is to define when the highlighting is to be applied by the hotspot module 510. The highlight profile (including both the selection of the type of highlighting and/or the selection of parameters for the visual modification threshold) may be based on a default setting or may be customized by a user via the hotspot interface. As discussed above, in some non-limiting examples customization of the highlight profile by a user via the hotspot interface may include the use of non-human user input.

The term “highlighting” refers to any number of different visual modifications that can be used to enhance the visibility of the content within the hotspot. Highlighting may include examples in which the content of the hotspot is displayed with decreased transparency (e.g., 0% transparency) as compared to a transparency level with which the hotspot was displayed prior to the detection of the visual modification threshold. In some examples, highlighting may additionally, or alternatively, include other visual modifications. For example, highlighting may include enlarging the size of the hotspot relative to the other contents within the input source. In yet other non-limiting examples, highlighting may include other visual modifications such as, e.g., a blinking outline, a blinking fill, a shimmering or twinkling outline, a shimmering or twinkling fill, a color-changing outline, a color-changing fill, a shaking effect applied to the object, a size-changing effect applied to the object, a rotational effect applied to the object, a movement applied to the object, etc.

In some examples, the visual modifications encompassed by a highlighting profile can encompass both the hotspot, as well as portions of the content surrounding the hotspot in order to generate a desired highlighted effect. For example, a highlighted effect can be a perceived depth between the object and remaining content in the user display content, such that the object appears elevated or three-dimensional. A visual modification such as brightening and enlarging can be applied to the object itself in order to achieve this effect. In addition, visual modifications can be applied to an area surrounding the object—e.g., outside of the outline of the object—to create a drop shadow or blurring surrounding the object to achieve the depth or distance. This can result in, for example, the appearance of the area surrounding the object to be out of focus. In an embodiment, the degree of visual modification (e.g., brightening, enlarging, darkening, shading, blurring, etc.) as well as the area to which the visual modification is applied can be calculated and applied based on a desired measure of distance or depth between the object and the surroundings of the object.

In some examples, it may be desirable to provide a user with a visual indication that portions of content have been designated as hotspots, thereby signaling to a user that these areas can be selected by the user for enhanced viewing. Accordingly, in various examples, the hotspots may be provided with some form of pre-threshold highlighting—even in the absence of the detection of a predetermined visual modification threshold. For example, an outline of the portion of the content defining the hotspot may be emphasized by applying highlighting to, or otherwise emphasizing, the outline of that portion of content.

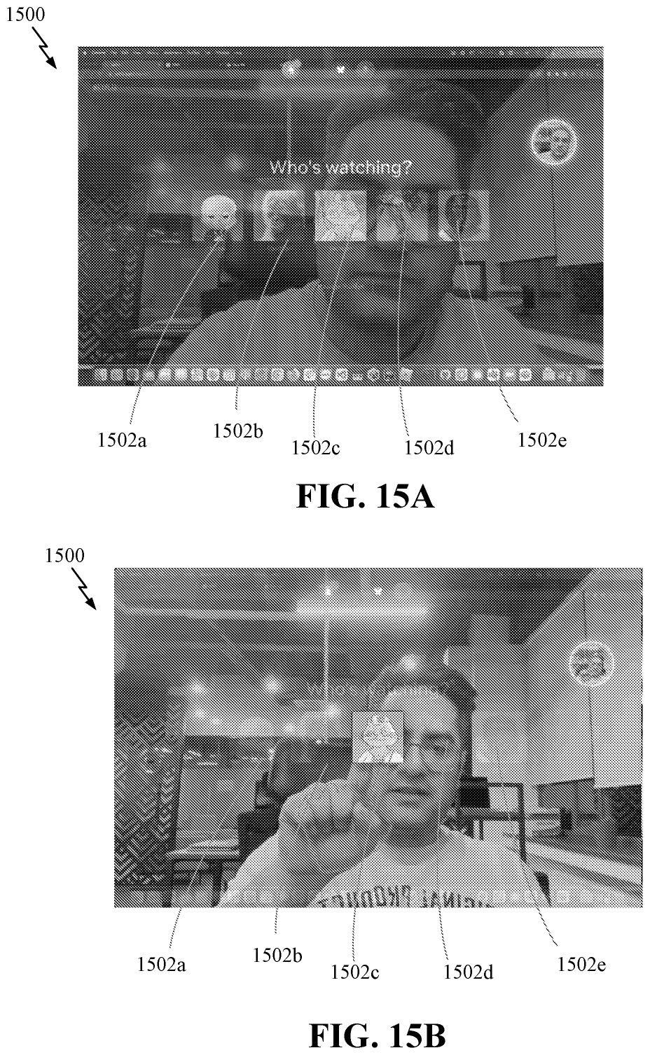

Referring to FIG. 15A, a multi-layer display 1500 generated using the hotspot module 510, and based on a first input corresponding to a video feed of a user (e.g., received from communication application 225) and a second input corresponding to a user's desktop GUI, is shown according to one non-limiting example. The content from the user's desktop GUI used in generating the multi-layer display 1500 corresponds to the same webpage displayed in, and discussed with reference to, the user's desktop GUI of FIG. 13. As similarly discussed with reference to FIG. 13, in the multi-layer display 1500, portions of the content from the user's desktop GUI have been designated as hotspots 1502a, 1502b, 1502c, 1502d, 1502e by the hotspot module 510. Additionally, for each hotspot 1502a-1502e, the hotspot module 510 has generated a hotspot layer having an assigned highlight profile in accordance with the processes described with reference to blocks 1204 and 1206 above.

In the multi-layer display 1500 of FIG. 15A, the portions of content 1502a, 1502b, 1502c, 1502d, 1502e designated as hotspots are shown as being modified with pre-threshold highlighting according to one non-limiting example. As shown in FIG. 15A, even prior to the detection of a visual modification threshold, the transparency of the content corresponding to of the hotspots 1502a, 1502b, 1502c, 1502d, 1502e is adjusted by the hotspot module 510 to make the content of the hotspots 1502a, 1502b, 1502c, 1502d, 1502e slightly less transparent (i.e., more opaque) relative to the other content from the user's desktop GUI—and thus easier to view by a user. Thus—even in the absence of a detected predetermined visual modification threshold—the pre-threshold highlighting provided by the hotspot module 510 to each of the hotspots 1502a-1502e increases the visibility of the corresponding contents from the user's desktop GUI. As will be appreciated, in other examples the pre-threshold highlighting may alternatively, or additionally, include other visual modifications besides modifications to transparency that enhance the viewability of the contents of the hotspots 1502a, 1502b, 1502c, 1502d, 1502e as compared to the other content from the user's desktop GUI.

In some examples, the other content from the user's desktop GUI (i.e., the portions of the content from the user's desktop GUI not corresponding to hotspots 1502a-1502e) may be completely unmodified (i.e., may correspond directly to the original content received from the user's desktop GUI). Alternatively, in other examples (e.g., examples in which the content modification module 504 visually enhances content using both the input manipulation module 508 and the hotspot module 510), the other content from the user's desktop GUI may instead be modified content generated by modifying the original content from the user's desktop GUI using the input manipulation module 508 as described with reference to FIG. 10. As will be appreciated, this description of other content as including the non-hotspot portions of content from an input source that: a) corresponds directly to the original content from the input source or b) corresponds to modified content generated by modifying the original content from the input source using the input manipulation module 508 is applicable in any use of the hotspot module 510 (i.e., is not limited to the use of the hotspot module 510 in generating the multi-layer display 1500 discussed with reference to FIGS. 15A and 15B).

FIG. 15B illustrates the multi-layer display 1500 of FIG. 15A following the detection of a predetermined visual modification threshold for hotspot 1502c. As shown in FIG. 15B, upon detecting the predetermined visual modification threshold for hotspot 1502c (e.g., a user pointing to hotspot 1502c), the hotspot layer associated with hotspot 1502c is applied to the contents from the user's desktop GUI. The application of this associated hotspot layer—with its assigned highlight profile specific to hotspot 1502c—to the user's desktop GUI provides the portion of the contents of user's desktop GUI associated with hotspot 1502c with additional highlighting beyond that provided by the pre-threshold highlighting—thereby further making the content of hotspot 1502c more easily viewable by the user. As also shown in FIG. 15B, upon the detection of one of the hotspots (i.e., hotspot 1502c) being selected, the pre-threshold highlighting applied to the remaining hotspots (i.e., 1502a, 1502b, 1502d, and 1502e) may optionally temporarily be removed (i.e., such that the transparencies of these hotspot revert to the increased transparency level of the remaining content within the input layer) while hotspot 1502c is selected.

Referring now to FIG. 12, at blocks 1208 and 1210, the hotspot module monitors whether a predetermined visual modification threshold has been triggered. As one non-limiting example, a predetermined visual modification threshold may correspond to the detection of a cursor within a portion of the content designated as the hotspot. Additional details with regard to various predetermined visual modification thresholds that may be used to signal when a highlight profile is to be applied to a hotspot are described in a co-pending U.S. Patent Application No. 63/407,489, titled “APPLYING VISUAL MODIFIERS TO OBJECTS OF INTEREST SELECTED BY A POINTER FROM A VIDEO FEED IN A FRAME BUFFER VIA PROCESSING CIRCUITRY” which is incorporated by reference herein in its entirety.

For content having more than one hotspot, the hotspot interface provided by the hotspot module may provide a user with the option to assign different predetermined visual modification threshold settings to each of the different hotspots. The hotspot interface may optionally also provide a user with the ability to vary other features related to the predetermined visual modification threshold. For example, the hotspot interface may provide a user with an option of selectively suspend the visual modification threshold, allowing the hotspot to remain in a highlighted state even after the visual modification threshold is no longer detected (e.g., even after a cursor has moved from the portion of the content designated as the hotspot). In some examples, the hotspot module may optionally also provide a user with the ability to highlight each of the multiple hotspots within the content simultaneously in response to the detection of a single trigger (e.g., in response to a visual modification threshold of any one of the hotspots being detected).

At block 1212, upon detection of a predetermined visual modification threshold for a hotspot, the hotspot layer corresponding to the hotspot is applied to input source. The resulting visually modified content of the input source is used to generate a hotspot output layer at block 1214. This hotspot output layer generated at block 1214 is then superimposed relative to the content from other input source to define a multi-layer display in accordance with the description related to block 608 discussed above with reference to FIG. 6.

### Further Examples Having a Variety of Features

The disclosure may be further understood by way of the following non-limiting examples:

Example 1: A method, apparatus, and non-transitory computer-readable medium for enhancing readability of a multi-layer graphical user interface comprises: generating a platform GUI in a display area of a device; receiving digital content from a first content input source; receiving digital content from a second content input source; generating a content output layer for each of the content input sources, wherein a first content output layer is generated based on modifying the digital content of the first content input source in accordance with a first enhancement profile and a second content output layer is generated based on modifying the digital content of the second content input source with a second enhancement profile; and superimposing the content output layers relative to one another within the platform GUI.

Example 2: The method, apparatus, and non-transitory computer-readable medium according to Example 1, wherein each enhancement profile identifies: a number of duplicate layers to be generated; and one or more specific image variable parameters that are to be applied to each duplicate layer.

Example 3: The method, apparatus, and non-transitory computer-readable medium according to any of Examples 1 or 2, wherein generating the first content output layer includes: generating one or more duplicate layers of the digital content of the first content input source, the number of generated duplicate layers corresponding to the number identified in the first enhancement profile; for each generated duplicate layer, modifying the digital content of the duplicate layer based on the specific one or more image variable parameters assigned to the duplicate layer; and compiling each of the modified duplicate layers.

Example 4: The method, apparatus, and non-transitory computer-readable medium according to any of Examples 1-3, wherein the first enhancement profile is different than the second enhancement profile.

Example 5: The method, apparatus, and non-transitory computer-readable medium according to any of Examples 1-4, wherein the enhancement profiles are assigned in response to a user selection of a preconfigured enhancement setting.

Example 6: The method, apparatus, and non-transitory computer-readable medium according to any of Examples 1-5, wherein the enhancement profiles are assigned based on an assessment of the color profiles of the digital content of each of the first content input source and second content input source.

Example 7: The method, apparatus, and non-transitory computer-readable medium according to any of Examples 1-6, wherein the first enhancement profile is assigned based on an identification of the type of digital content received from the first content input source.

Example 8: The method, apparatus, and non-transitory computer-readable medium according to any of Examples 1-7, wherein the first content input source is a runtime GUI of a communications platform.

Example 9: The method, apparatus, and non-transitory computer-readable medium according to any of Examples 1-8, wherein the second content input source is a desktop GUI.

Example 10: The method, apparatus, and non-transitory computer-readable medium according to any of Examples 1-9, the method further comprising receiving digital content from a third content input source.

Example 11: The method, apparatus, and non-transitory computer-readable medium according to Example 10, wherein the third content input source corresponds to a hotspot identified within the desktop GUI.

Example 12: The method, apparatus, and non-transitory computer-readable medium according to Example 11, further comprising: applying a highlight profile to the hotspot; generating a hotspot output layer based on modifying the digital content of the hotspot in accordance with the highlight profile; and superimposing the hotspot output layer within the platform GUI.

Example 13: The method, apparatus, and non-transitory computer-readable medium according to Example 12, wherein the hotspot output layer is arranged in front of each of the first content output layer and the second content output layer.

Example 14: The method, apparatus, and non-transitory computer-readable medium according to any of Examples 1-13, wherein the second content output layer is entirely transparent.

Example 15: The method, apparatus, and non-transitory computer-readable medium according to any of Examples 1-14, wherein the second content output layer is semi-transparent.

Example 16: The method, apparatus, and non-transitory computer-readable medium according to any of Examples 2-14, wherein the one or more specific image variable parameters includes a value that corresponds to at least one of: hue, saturation, brightness, transparency contrast, color map, blur, or sharpness.

Example 17: A method, apparatus, and non-transitory computer-readable medium for enhancing readability of a multi-layer graphical user interface comprises: a memory; and a processor coupled to the memory, the processor configured to: generate a platform GUI in a display area of a display device; receive digital content from a first content input source; receive digital content from a second content input source; generate a content output layer for each of the content input sources, wherein a first content output layer is generated based on modifying the digital content of the first content input source in accordance with a first enhancement profile and a second content output layer is generated based on modifying the digital content of the second content input source with a second enhancement profile; and superimpose the content output layers relative to one another within the platform GUI.

Example 18: The method, apparatus, and non-transitory computer-readable medium according to Example 17, wherein each enhancement profile identifies: a number of duplicate layers to be generated; and one or more specific image variable parameters that are to be applied to each duplicate layer.

Example 19: The method, apparatus, and non-transitory computer-readable medium according to any of Examples 17 or 18, wherein to generate the first content output layer, the processor is further configured to: generate one or more duplicate layers of the digital content of the first content input source, the number of generated duplicate layers corresponding to the number identified in the first enhancement profile; for each generated duplicate layer, modify the digital content of the duplicate layer based on the specific one or more image variable parameters assigned to the duplicate layer; and compile each of the modified duplicate layers.

Example 20: The method, apparatus, and non-transitory computer-readable medium according to any of Examples 17-19, wherein the first content input source is a runtime GUI of a communications platform.

Example 21: The method, apparatus, and non-transitory computer-readable medium according to any of Examples 17-20, wherein the second content input source is a GUI of the device.

Other examples and uses of the disclosed technology will be apparent to those having ordinary skill in the art upon consideration of the specification and practice of the invention disclosed herein. The specification and examples given should be considered exemplary only, and it is contemplated that the appended claims will cover any other such embodiments or modifications as fall within the true scope of the invention.

The Abstract accompanying this specification is provided to enable the United States Patent and Trademark Office and the public generally to determine quickly from a cursory inspection the nature and gist of the technical disclosure and in no way intended for defining, determining, or limiting the present invention or any of its embodiments.

What is claimed is:

1. A method for enhancing readability of a graphical user interface, the method comprising:
generating a platform GUI in a display area of a device;
receiving digital content from a first content input source;
receiving digital content from a second content input source;
generating a content output layer for each of the content input sources, wherein a first content output layer is generated based on modifying the digital content of the first content input source in accordance with a first enhancement profile and a second content output layer is generated based on modifying the digital content of the second content input source with a second enhancement profile; and
superimposing the content output layers relative to one another within the platform GUI.

2. The method of claim 1, wherein each enhancement profile identifies:
a number of duplicate layers of the digital content of the content input source to be generated; and
for each duplicate layer to be generated, specific modifications to one or more specific image variable parameters that are to be applied to the digital content of the corresponding duplicate layer.

3. The method of claim 2, wherein the one or more specific image variable parameters includes a value that corresponds to at least one of: hue, saturation, brightness, transparency contrast, color map, blur, or sharpness.

4. The method of claim 2, wherein generating the first content output layer includes:
generating one or more duplicate layers of the digital content of the first content input source, the number of generated duplicate layers corresponding to the number identified in the first enhancement profile;
for each generated duplicate layer, modifying the digital content of the duplicate layer based on the specific modifications to the one or more image variable parameters identified for the corresponding duplicate layer; and
compiling each of the modified duplicate layers.

5. The method of claim 1, wherein the first enhancement profile is different than the second enhancement profile.

6. The method of claim 1, wherein the enhancement profiles are assigned in response to a user selection of a preconfigured enhancement setting.

7. The method of claim 1, wherein the enhancement profiles are assigned based on an assessment of the color profiles of the digital content of each of the first content input source and second content input source.

8. The method of claim 1, wherein the first enhancement profile is assigned based on an identification of the type of digital content received from the first content input source.

9. The method of claim 1, wherein the first content input source is a runtime GUI of a communications platform.

10. The method of claim 9, wherein the second content input source is a desktop GUI.

11. The method of claim 10, the method further comprising receiving digital content from a third content input source.

12. The method of claim 11, wherein the third content input source corresponds to a hotspot identified within the desktop GUI.

13. The method of claim 12, further comprising:
applying a highlight profile to the hotspot;
generating a hotspot output layer based on modifying the digital content of the hotspot in accordance with the highlight profile; and
superimposing the hotspot output layer within the platform GUI.

14. The method of claim 13, wherein the hotspot output layer is arranged in front of each of the first content output layer and the second content output layer.

15. The method of claim 12, wherein the second content output layer is entirely transparent.

16. The method of claim 12, wherein the second content output layer is semi-transparent.

17. A device for enhancing readability of a graphical user interface, the device comprising:
a memory; and
a processor coupled to the memory, the processor configured to:
generate a platform GUI in a display area of a display device;
receive digital content from a first content input source;
receive digital content from a second content input source;
generate a content output layer for each of the content input sources, wherein a first content output layer is generated based on modifying the digital content of the first content input source in accordance with a first enhancement profile and a second content output layer is generated based on modifying the digital content of the second content input source with a second enhancement profile; and
superimpose the content output layers relative to one another within the platform GUI.

18. The device of claim 17, wherein each enhancement profile identifies:
a number of duplicate layers of the digital content of the input source to be generated; and
for each duplicate layer to be generated, specific modifications to one or more specific image variable parameters that are to be applied to the digital content of the corresponding duplicate layer.

19. The device of claim 17, wherein to generate the first content output layer, the processor is further configured to:
generate one or more duplicate layers of the digital content of the first content input source, the number of generated duplicate layers corresponding to the number identified in the first enhancement profile;
for each generated duplicate layer, modify the digital content of the duplicate layer based on the specific modifications to the one or more image variable parameters identified for the corresponding duplicate layer; and
compile each of the modified duplicate layers.

20. The device of claim 17, wherein the first content input source is a runtime GUI of a communications platform.

21. The device of claim 19, wherein the second content input source is a GUI of the device.
